(19) United States
(12) Patent Application Publication
(10) Pub. No.: US 2019/0381500 A1
(43) Pub. Date: Dec. 19, 2019

(54) CELL CONTAINED CONTAINER AND CELL CONTAINED CONTAINER PRODUCING METHOD, AND CELL CHIP

(71) Applicants: Daisuke TAKAGI, Kanagawa (JP); Waka Lin, Tokyo (JP); Takahiko Matsumoto, Kanagawa (JP); Manabu Seo, Kanagawa (JP); Tomoyuki Aratani, Kanagawa (JP); Takeru Suzuki, Saitama (JP); Hidekazu Yaginuma, Kanagawa (JP); Satoru Nagasawa, Kanagawa (JP); Shinnosuke Koshizuka, Kanagawa (JP); Tomoaki Nakayama, Tokyo (JP); Minoru Ko, Baltimore, MD (US)

(72) Inventors: Daisuke TAKAGI, Kanagawa (JP); Waka Lin, Tokyo (JP); Takahiko Matsumoto, Kanagawa (JP); Manabu Seo, Kanagawa (JP); Tomoyuki Aratani, Kanagawa (JP); Takeru Suzuki, Saitama (JP); Hidekazu Yaginuma, Kanagawa (JP); Satoru Nagasawa, Kanagawa (JP); Shinnosuke Koshizuka, Kanagawa (JP); Tomoaki Nakayama, Tokyo (JP); Minoru Ko, Baltimore, MD (US)

(21) Appl. No.: 16/436,100

(22) Filed: Jun. 10, 2019

(30) Foreign Application Priority Data
Jun. 14, 2018 (JP) 2018-114020
Mar. 20, 2019 (JP) 2019-052817

(51) Int. Cl. B01L 3/00

(52) U.S. Cl. CPC B01L 3/5027

(57) ABSTRACT

Provided is a cell contained container including at least two concaves, wherein the concaves contain cells, wherein a number of kinds of the cells is at least two with respect to the cell contained container, and wherein a shortest distance between centers of most closely adjacent two concaves of the at least two concaves is 9.0 mm or less. In a preferable mode, the concaves contain a liquid, and a total liquid amount of the liquid with respect to the concaves is 10.0 microliters or less. In a more preferable mode, a filling accuracy in terms of a number in which the cells are contained in the concaves is 30% or lower.

### CROSS-REFERENCE TO RELATED APPLICATIONS

The present application claims priority under 35 U.S.C. § 119 to Japanese Patent Application No. 2018-114020 filed Jun. 14, 2018 and Japanese Patent Application No. 2019-052817 filed Mar. 20, 2019. The contents of which are incorporated herein by reference in their entirety.

### BACKGROUND OF THE INVENTION

### Field of the Invention

The present disclosure relates to a cell contained container and a cell contained container producing method, and a cell chip.

### Description of the Related Art

In recent years, there has been increasing demand for tools for in-vitro tests for evaluating toxicity and medical efficacy using cells.

As one reason for the increasing demand, there have been needs for reduction in the number of experimental animals and for alternatives to animal testing, along with promotion of 3Rs of animal testing (“Replacement”, “Reduction”, and “Refinement”).

As a reason different from promotion of 3Rs of animal testing described above, in-vitro experiments using living cells have many advantages such as saving of costs taken for experimental animals and saving of the test time.

For in-vitro experiments using living cells, for example, for in-vitro reproduction of intercellular interactions, there has been proposed a cell culture container on which microwells for containing cells are disposed uniformly, (for example, see Japanese Unexamined Patent Application Publication No. 2015-47077).

There has also been proposed a plate-shaped container, which is a plate including wells, wherein the shape of the wells for containing a granular material is designed to conform to the size of the material to be contained in order that only one granular material may be contained per well, while securing a liquid amount needed (for example, see Japanese Unexamined Patent Application Publication No. 2010-112839).

### SUMMARY OF THE INVENTION

According to one aspect of the present disclosure, a cell contained container includes at least two concaves. The concaves contain cells. The number of kinds of the cells is at least two with respect to the cell contained container. A shortest distance between centers of most closely adjacent two concaves of the concaves is 9.0 mm or less.

### BRIEF DESCRIPTION OF THE DRAWINGS

FIG. 1 is a graph plotting a relationship between an average value x and a coefficient of variation CV for number of cells;

FIG. 2 is a perspective view illustrating an example of a cell contained container of the present disclosure;

FIG. 3 is a perspective view illustrating another example of a testing device of the present disclosure;

FIG. 4 is a side view of FIG. 3;

FIG. 5A is a flowchart illustrating an example of a cell contained container producing method of the present disclosure;

FIG. 5B is a flowchart illustrating another example of a cell contained container producing method of the present disclosure;

FIG. 5C is a flowchart illustrating another example of a cell contained container producing method of the present disclosure;

FIG. 6A is an exemplary diagram illustrating an example of an electromagnetic valve-type discharging head;

FIG. 6B is an exemplary diagram illustrating an example of a piezo-type discharging head;

FIG. 6C is an exemplary diagram illustrating a modified example of the piezo-type discharging head illustrated in FIG. 6B;

FIG. 7A is an exemplary graph plotting an example of a voltage applied to a piezoelectric element;

FIG. 7B is an exemplary graph plotting another example of a voltage applied to a piezoelectric element;

FIG. 8A is an exemplary diagram illustrating an example of a liquid droplet state;

FIG. 8B is an exemplary diagram illustrating an example of a liquid droplet state;

FIG. 8C is an exemplary diagram illustrating an example of a liquid droplet state;

FIG. 9 is a schematic diagram illustrating an example of a dispensing device configured to land liquid droplets sequentially into concaves;

FIG. 10 is an exemplary diagram illustrating an example of a liquid droplet forming device;

FIG. 11 is a diagram illustrating hardware blocks of a control unit of the liquid droplet forming device of FIG. 10;

FIG. 12 is a diagram illustrating functional blocks of a control unit of the liquid droplet forming device of FIG. 11;

FIG. 13 is a flowchart illustrating an example of an operation of a liquid droplet forming device;

FIG. 14 is an exemplary diagram illustrating a modified example of a liquid droplet forming device;

FIG. 15 is an exemplary diagram illustrating another modified example of a liquid droplet forming device;

FIG. 16A is a diagram illustrating a case where two fluorescent particles are contained in a flying liquid droplet;

FIG. 16B is a diagram illustrating a case where two fluorescent particles are contained in a flying liquid droplet;

FIG. 17 is a graph plotting an example of a relationship between a luminance Li when particles do not overlap each other and a luminance Le actually measured;

FIG. 18 is an exemplary diagram illustrating another modified example of a liquid droplet forming device;

FIG. 19 is an exemplary diagram illustrating another example of a liquid droplet forming device;

FIG. 20 is an exemplary diagram illustrating an example of a method for counting cells that have passed through a micro-flow path;

FIG. 21 is an exemplary diagram illustrating an example of a method for capturing an image of a portion near a nozzle portion of a discharging head;

FIG. 22 is a graph plotting a relationship between a probability P (>2) and an average cell number;

FIG. 23 is a graph plotting a cell survival rate in Example 1;

FIG. 24 is a graph plotting a cell membrane damage rate in Example 1;

FIG. 25 is a graph plotting an inflammatory substance production in Example 1;

FIG. 26A is a view illustrating an example of dispensing by a dispenser;

FIG. 26B is a view illustrating an example of dispensing by a dispenser;

FIG. 26C is a view illustrating an example of dispensing by a dispenser; and

FIG. 26D is a view illustrating an example of dispensing by a dispenser.

### DESCRIPTION OF THE EMBODIMENTS

### (Cell Contained Container)

A cell contained container of the present disclosure includes at least two concaves. The concaves contain cells. The number of kinds of the cells is at least two with respect to the cell contained container. A shortest distance between centers of most closely adjacent two concaves of the concaves is 9.0 mm or less. The cell contained container includes other members as needed.

The present inventors have obtained the following findings as a result of studies into a cell contained container that enables an evaluation test using cells to be efficiently conducted with one container.

For example, existing cell culture containers and plate-shaped containers need cells to be filled in the containers by users when conducting tests. The problem here is, it is difficult to fill desired kinds of cells by desired numbers into predetermined wells, and hence it is difficult to efficiently conduct an evaluation test using cells, with only one container. Moreover, there is a problem that existing cell culture containers and plate-shaped containers are not ensured to have predetermined wells accurately filled with desired kinds of cells by desired numbers.

The present inventors have found that a container including at least two concaves and at least two kinds of cells and having the shortest distance of 9.0 mm or less between the centers of most closely adjacent two concaves of the concaves, i.e., a container with a large number of and many kinds of cells per area can be a container that enables an evaluation test using cells to be efficiently conducted with one container.

The present disclosure has an object to provide a cell contained container that enables an evaluation test using cells to be efficiently conducted with one container.

The present disclosure can provide a cell contained container that enables an evaluation test using cells to be efficiently conducted with one container.

### <Concave>

A concave is a section provided over the container, and contains cells described below, and is a place where any other member is disposed.

The number of concaves is at least two, preferably five or more, and more preferably 50 or more.

In the cell contained container of the present disclosure, the shortest distance between the centers of the most closely adjacent two concaves is 9.0 mm or less, preferably 5.0 mm or less, more preferably 4.5 mm or less, and yet more preferably 2.25 mm or less. The shortest distance between the centers of the most closely adjacent two concaves may herein be referred to as the shortest concave-concave pitch, or the shortest pitch.

Being most closely adjacent means the shortest center-center distance to one concave, when the center-center distances to the one concave is compared among adjacent concaves of the one concave. The center refers to the center of gravity of the shape of the opening of the concave.

The shortest distance refers to the length of the shortest line connecting two points, i.e., the length of the line segment connecting the two points.

Examples of an article including at least two concaves with the shortest distance between the centers of the most closely adjacent two concaves of 5.0 mm or less include a multi-well plate and a microwell slide (hereinafter may also be referred to as chip).

Examples of the multi-well plate include a 96-well, 384-well, or 1,536-well plate.

Examples of the microwell slide include a 192-well, 768-well, or 3,456-well microwell slide. A microwell slide can be produced by pasting a hole-opened sheet of dimethyl polysiloxane (PDMS) over a base material having a high light transmittance and a low autofluorescence.

The number of concaves is not particularly limited and may be appropriately selected depending on the intended purpose, so long as there are at least two concaves. For example, a number greater than or equal to 192 but less than or equal to 3,456 is preferable. When the number of concaves is 192 or greater but 3,456 or less, a large number of samples can be treated with one cell contained container. Therefore, it is possible to efficiently conduct an evaluation test using cells with only one container.

For example, the shape, the volume, the material, and the color of the concave are not particularly limited and may be appropriately selected depending on the intended purpose.

The shape of the concave is not particularly limited and may be appropriately selected depending on the intended purpose so long as cells described below can be located in the concave. Examples of the shape of the concave l include: concaves such as a flat bottom, a round bottom, a U bottom, and a V bottom; and sections on a substrate. The shape of the concave to be used is different depending on the specifications of a testing device. A round bottom is common in PCR whereas a flat bottom is common in testing by optical observation such as a microscope.

The volume of the concave is not particularly limited, may be appropriately selected depending on the intended purpose, and is preferably 0.1 microliters or greater but 1,000 microliters or less in consideration of the amount of a reagent used in a common evaluation method, and more preferably 0.1 microliters or greater but 10 microliters or less because a minute liquid amount is desirable in evaluation using a rare reagent.

Examples of the color of the concave include transparent colors, semi-transparent colors, chromatic colors, and complete light-shielding colors. In testing of an optical system, occurrence of interference between adjacent concaves is unpreferable. Therefore, a container with a transparent bottom surface and colored side surfaces is more preferable.

The material of the concave is not particularly limited and may be appropriately selected depending on the intended purpose so long as the material has a low affinity with cells described below, i.e., cell non-adhesiveness. Examples of the material of the concave include a cell non-adhesive material. Examples of the cell non-adhesive material include organic materials and inorganic materials described below. One of these materials may be used alone or two or more of these materials may be used in combination. Among these materials, a material to which a cell adhesive material is easily adsorbable is preferable. When a cell adhesive material is easily adsorbable to the material of the container, the cell adhesive material can adhere to the container in a stable state when the cell adhesive material is discharged onto the container corresponding to the bottom of the concave.

### —Cell Non-Adhesive Material—

Cell non-adhesiveness refers to a lower adhesiveness with intended cells than at least the adhesiveness of the cell adhesive material to be used.

A method for measuring cell non-adhesiveness is not particularly limited and may be appropriately selected depending on the intended purpose. Examples of the method include a method of measuring and evaluating adhesiveness of cells with the container by inserting a needle-like AFM probe into cells cultured over the container and lifting the probe to peel the cells from the container to measure a load applied on the probe by AFM. As another method, for example, there is a simple method of flowing, for example, pure water over cells cultured over the container, and evaluating cell non-adhesiveness by adhesion peeling rates of the cells from the container before and after flowing the pure water.

The cell non-adhesive material is not particularly limited and may be appropriately selected depending on the intended purpose. A water-repellent material is preferable. When the cell non-adhesive material is a water-repellent material, there is an advantage that the cell non-adhesive material is more difficult for cells to adhere.

The cell non-adhesive material is not particularly limited and may be appropriately selected depending on the intended purpose. A silicon-containing material is preferable.

The silicon-containing material is not particularly limited and may be appropriately selected depending on the intended purpose. In terms of biocompatibility, polydimethyl siloxane (PDMS) is preferable.

The organic materials are not particularly limited and may be appropriately selected depending on the intended purpose. Examples of the organic materials include polyethylene terephthalate (PET), polystyrene (PS), polycarbonate (PC), TAC (triacetyl cellulose), polyimide (PI), nylon (Ny), low density polyethylene (LDPE), medium density polyethylene (MDPE), vinyl chloride, vinylidene chloride, polyphenylene sulfide, polyether sulfone, polyethylene naphthalate, polypropylene, acrylic-based materials such as urethane acrylate, cellulose, and silicone-based materials such as polydimethyl siloxane (PDMS).

The inorganic materials are not particularly limited and may be appropriately selected depending on the intended purpose. Examples of the inorganic materials include glass and ceramics.

### —Cell Adhesive Material—

Further, the bottom of the concave is provided with a cell adhesive material having a higher cell adhesiveness than cell adhesiveness of the container.

The cell adhesive material is not particularly limited and may be appropriately selected depending on the intended purpose. Examples of the cell adhesive material include a protein selected from the extracellular matrix.

Examples of the protein selected from the extracellular matrix include fibronectin, laminin, tenascin, vitronectin, RGD (arginylglycylaspartic acid) sequence-containing peptides, YIGSR (tyrosine-isoleucine-glycine-serine-arginine) sequence-containing peptides, collagen, atelocollagen, and gelatin. Additional examples of the protein selected from the extracellular matrix include mixtures of the proteins described above, matrigel, Pura Matrix, and fibrin. Among these proteins, collagen, or IMATRIX 511 (available from Nippi Inc.) mimicking a partial structure of laminin used in, for example, stem cell culture, is preferable. Further examples of the protein selected from the extracellular matrix include basic polymers such as polylysine and basic compounds such as aminopropyl triethoxysilane.

Examples of a method for providing the cell adhesive material in the concave include a method of applying a solution containing the cell adhesive material to the concave. In this case, the solution may contain biocompatible particles.

The biocompatible particles are not particularly limited and may be appropriately selected so long as the biocompatible particles have compatibility with living organisms such as cells. Examples of the biocompatible particles include gelatin particles and collagen particles. One of these kinds of particles may be used alone or two or more of these kinds of particles may be used in combination.

When the biocompatible particles are gelatin particles, gelatin as the raw material of the gelatin particles is not particularly limited and may be appropriately selected depending on the intended purpose. Examples of the gelatin include a product named: APH-250 (available from Nitta Gelatin Inc.).

The gelatin particles having a particulate shape can improve adhesiveness of cells with the base material, and can be located at a desired position without being degraded by the cells for a longer time than gelatin having a non-particulate shape. Therefore, there are advantages that the gelatin particles can improve adhesiveness of cells and are used as a source of nutrients for the cells for a long term.

It is preferable that the biocompatible particles be cross-linked by a cross-linking agent in the structure.

The cross-linking agent is not particularly limited and may be appropriately selected depending on the intended purpose. Examples of the cross-linking agent include: aldehydes such as glutaraldehyde and formaldehyde; glycidyl ethers such as ethylene propylene diglycidyl ether, glycerol polyglycidyl ether, diglycerol polyglycidyl ether, sorbitol polyglycidyl ether, and ethylene glycol diglycidyl ether; isocyanates such as hexamethylene diisocyanate, α-tolidine isocyanate, tolylene diisocyanate, naphthylene-1,5-diisocyanate, 4,4-diphenylmethane diisocyanate, and triphenylmethane-4,4,4-triisocyanate; calcium gluconate; methyl (1S,2R,6S)-2-hydroxy-9-(hydroxymethyl)-3-oxabicyclo [4.3.0] nona-4,8-diene-5-carboxylate (genipin); combination of polyphenol and an oxidant such as horseradish peroxidase; and a compound containing a succinimide group. One of these cross-linking agents may be used alone or two or more of these cross-linking agents may be used in combination. Among these cross-linking agents, aldehydes are preferable and glutaraldehyde is more preferable.

The content of the cross-linking agent is preferably 1% by mass or greater but 20% by mass or less and more preferably 2% by mass or greater but 10% by mass or less relative to the total amount of the raw material of the biocompatible particles.

The content of the biocompatible particles is preferably 0.5% by mass or greater but 10% by mass or less and more preferably 1% by mass or greater but 5% by mass or less relative to the total amount of the solution containing the cell adhesive material.

### —Preparation Example of Sample Liquid Containing Cell Adhesive Material—

The biocompatible particles are dispersed in pure water obtained with a pure water producing apparatus (product name: GSH-2000, available from ADVANTEC Co., Ltd.), at a concentration of 0.5% by mass. The liquid amount for measurement is 5 mL. The biocompatible particles are subjected to dispersion treatment by stirring with a stirrer including a 20 mm rotor, with stirring kept for about one day at 200 rpm. In this way, the sample liquid can be prepared.

### —Measurement Conditions—

Solvent: water (refractive index: 1.3314, viscosity at 25 degrees C.: 0.884 mPa·s (cP), with appropriate setting of the optimum light volume adjustment by an ND filter)
Measuring probe: a probe for a concentrated system
Measurement routine: measurement at 25 degrees C. for 180 seconds, then measurement at 25 degrees C. for 600 seconds (monitoring of the change of the particle diameter during gradual change of the liquid temperature from 25 degrees C. to 35 degrees C. started in response to temperature change to 35 degrees C. on the main body side), and then measurement at 35 degrees C. for 180 seconds

It is preferable that the concave further contain a liquid.

### —Liquid—

The liquid is not particularly limited and may be appropriately selected depending on the intended purpose so long as the liquid can be used as a dispersion medium in which cells are dispersed in production of the cell contained container of the present disclosure described below. Examples of the liquid include phosphate buffered saline.

Separately from the liquid, for example, a culture medium for cell culture (may also be referred to as broth), a humectant, a dispersant, and a pH adjustor may also be added.

The volume of the liquid is not particularly limited and may be appropriately selected depending on the intended purpose. The total liquid amount of the liquid in the concaves constituting the cell contained container is preferably 10.0 microliters or less. When the total liquid amount of the liquid in the concaves constituting the cell contained container is 10.0 microliters or less, it is possible to save the amount of the reagent (for example, cells and drugs) used in one test.

The method for measuring the volume of the liquid is not particularly limited and may be appropriately selected depending on the intended purpose. Examples of the method include gravimetric determination with a microbalance before and after application of the liquid, and liquid surface sensing by ultrasonic scanning over the liquid surface after the liquid is applied (for example, an instrument named: LABCYTE (registered trademark), available from Kiko-Tech Co., Ltd.).

### —Cells—

Cells are not particularly limited and may be appropriately selected depending on the intended purpose.

In the cell contained container of the present disclosure, the number of kinds of cells is at least two with respect to the container constituting the cell contained container. In other words, the number of kinds of cells to be located in the cell contained container, i.e., the number of kinds of cells to be contained in the container, i.e., the cell contained container is at least two.

For example, in the case of locating two kinds of cells (cells A and cells B) over a container including concaves at 96 positions, cells A may be located at 48 positions and cells B may be located at the remaining 48 positions, or cells A and cells B may be located in the concaves at all of 96 positions. How to locate cells in the concaves of the container may be appropriately selected.

Here, not only do the kinds of cells refer to different kinds of cells such as nerve cells and muscle cells, but also cells obtained from different sources such as a nerve cell a obtained from one mouse A and a nerve cell b obtained from another mouse B, although being cells of the same kind are regarded as different cell kinds. Also in the case of using cells obtained by differentiating pluripotent stem cells, pluripotent stem cells obtained from different donors are regarded as different cell kinds.

Cells are not particularly limited and may be appropriately selected depending on the intended purpose. All kinds of cells can be used regardless of whether the cells are eukaryotic cells, prokaryotic cells, multicellular organism cells, and unicellular organism cells. Living cells are preferable as cells.

The eukaryotic cells are not particularly limited and may be appropriately selected depending on the intended purpose. Examples of the eukaryotic cells include animal cells, insect cells, plant cells, fungi, algae, and protozoans. One of these kinds of eukaryotic cells may be used alone or two or more of these kinds of eukaryotic cells may be used in combination. Among these eukaryotic cells, animal cells are and fungi preferable.

Adherent cells may be primary cells directly taken from tissues or organs, or may be cells obtained by passaging primary cells directly taken from tissues or organs a few times, and may be appropriately selected depending on the intended purpose. Examples of adherent cells include differentiated cells and undifferentiated cells.

Differentiated cells are not particularly limited and may be appropriately selected depending on the intended purpose. Examples of differentiated cells include: hepatocytes, which are parenchymal cells of a liver; stellate cells; Kupffer cells; endothelial cells such as vascular endothelial cells, sinusoidal endothelial cells, and corneal endothelial cells; fibroblasts; osteoblasts; osteoclasts; periodontal ligament-derived cells; epidermal cells such as epidermal keratinocytes; epithelial cells such as tracheal epithelial cells, intestinal epithelial cells, cervical epithelial cells, and corneal epithelial cells; mammary glandular cells; pericytes; muscle cells such as smooth muscle cells and myocardial cells; renal cells; pancreatic islet cells; nerve cells such as peripheral nerve cells and optic nerve cells; chondrocytes; bone cells; differentiated cells derived from iPS cells; and differentiated cells derived from ES cells.

Undifferentiated cells are not particularly limited and may be appropriately selected depending on the intended purpose. Examples of undifferentiated cells include: pluripotent stem cells such as embryotic stem cells, which are undifferentiated cells, and mesenchymal stem cells having pluripotency; unipotent stem cells such as vascular endothelial progenitor cells having unipotency; induced Pluripotent Stem (iPS) cells; Embryonic Stem (ES) cells; and stem cells obtained from human bodies.

Fungi are not particularly limited and may be appropriately selected depending on the intended purpose. Examples of fungi include molds and yeast fungi. One of these kinds of fungi may be used alone or two or more of these kinds of fungi may be used in combination. Among these kinds of fungi, yeast fungi are preferable because the cell cycles are adjustable and monoploids can be used.

The cell cycle means a cell proliferation process in which cells undergo cell division and cells (daughter cells) generated by the cell division become cells (mother cells) that undergo another cell division to generate new daughter cells.

Yeast fungi are not particularly limited and may be appropriately selected depending on the intended purpose. For example, yeast fungi that are synchronously cultured to synchronize at a G0/G1 phase, and fixed at a G1 phase are preferable.

Further, for example, as yeast fungi, Bar1-deficient yeasts with enhanced sensitivity to a pheromone (sex hormone) that controls the cell cycle at a G1 phase are preferable. When yeast fungi are Bar1-deficient yeasts, the abundance ratio of yeast fungi with uncontrolled cell cycles can be reduced. This makes it easy to control the number of cells to be located.

The prokaryotic cells are not particularly limited and may be appropriately selected depending on the intended purpose. Examples of the prokaryotic cells include eubacteria and archaea. One of these kinds of prokaryotic cells may be used alone or two or more of these kinds of prokaryotic cells may be used in combination.

The cells may be cells that can emit light upon reception of light. With cells that can emit light upon reception of light, it is possible to land the cells into concaves while having a highly accurate control on the number of cells.

Reception of light means receiving of light.

An optical sensor means a passive sensor configured to collect, with a lens, any light in the range from visible light rays visible by human eyes to near infrared rays, short-wavelength infrared rays, and thermal infrared rays that have longer wavelengths than the visible light rays, to obtain, for example, shapes of target cells in the form of image data.

—Cells that can Emit Light Upon Reception of Light—

The cells that can emit light upon reception of light are not particularly limited and may be appropriately selected depending on the intended purpose so long as the cells can emit light upon reception of light. Examples of the cells include cells stained with a fluorescent dye, cells expressing a fluorescent protein, and cells labeled with a fluorescent-labeled antibody.

A cellular site stained with a fluorescent dye, expressing a fluorescent protein, or labeled with a fluorescent-labeled antibody is not particularly limited. Examples of the cellular site include a whole cell, a cell nucleus, and a cellular membrane.

### ———Fluorescent Dye———

Examples of the fluorescent dye include fluoresceins, azo dyes, rhodamines, coumarins, pyrenes, cyanines. One of these fluorescent dyes may be used alone or two or more of these fluorescent dyes may be used in combination. Among these fluorescent dyes, fluoresceins, azo dyes, and rhodamines are preferable, and eosin, Evans blue, trypan blue, rhodamine 6G, rhodamine B, and rhodamine 123 are more preferable.

As the fluorescent dye, a commercially available product may be used. Examples of the commercially available product include product name: EOSIN Y (available from Wako Pure Chemical Industries, Ltd.), product name: EVANS BLUE (available from Wako Pure Chemical Industries, Ltd.), product name: TRYPAN BLUE (available from Wako Pure Chemical Industries, Ltd.), product name: RHODAMINE 6G (available from Wako Pure Chemical Industries, Ltd.), product name: RHODAMINE B (available from Wako Pure Chemical Industries, Ltd.), and product name: RHODAMINE 123 (available from Wako Pure Chemical Industries, Ltd.).

### ———Fluorescent Protein———

Examples of the fluorescent protein include Sirius, EBFP, ECFP, mTurquoise, TagCFP, AmCyan, mTFP1, MidoriishiCyan, CFP, TurboGFP, AcGFP, TagGFP, Azami-Green, ZsGreen, EmGFP, EGFP, GFP2, HyPer, TagYFP, EYFP, Venus, YFP, PhiYFP, PhiYFP-m, TurboYFP, ZsYellow, mBanana, KusabiraOrange, mOrange, TurboRFP, DsRed-Express, DsRed2, TagRFP, DsRed-Monomer, AsRed2, mStrawberry, TurboFP602, mRFP1, JRed, KillerRed, mCherry, mPlum, PS-CFP, Dendra2, Kaede, EosFP, and KikumeGR. One of these fluorescent proteins may be used alone or two or more of these fluorescent proteins may be used in combination.

### —Fluorescent-Labeled Antibody—

The fluorescent-labeled antibody is not particularly limited and may be appropriately selected depending on the intended purpose so long as the fluorescent-labeled antibody is fluorescent-labeled. Examples of the fluorescent-labeled antibody include CD4-FITC and CD8-PE. One of these fluorescent-labeled antibodies may be used alone or two or more of these fluorescent-labeled antibodies may be used in combination.

The volume average particle diameter of the cells is preferably 30 micrometers or less, more preferably 15 micrometers or less, and particularly preferably 10 micrometers or less in a free state. When the volume average particle diameter of the cells is 30 micrometers or less, the cells can be suitably used in an inkjet method or a liquid droplet discharging unit such as a cell sorter.

The volume average particle diameter of the cells can be measured by, for example, a measuring method described below.

Ten microliters is extracted from a produced stained yeast dispersion liquid and poured onto a plastic slide formed of PMMA. Then, with an automated cell counter (product name: COUNTESS AUTOMATED CELL COUNTER, available from Invitrogen), the volume average particle diameter of the cells can be measured. The cell number can be obtained by a similar measuring method.

The number of cells to be contained in each concave has variation, i.e., a filling accuracy, where the variation occurs when cells are filled in the concave.

### [Filling Accuracy]

In the present disclosure, the filling accuracy means a relative value (percentage, %) of the variation in the number of cells filled in each concave, where the variation occurs when cells are filled in the concave. That is, the filling accuracy means a value expressing a coefficient of variation for the number of cells filled in the concave in percentage (%). The coefficient of variation is a value obtained by dividing standard deviation σ by an average value x, and expressed by Formula 1 below.

$$CV = \frac{σ}{x} σ = \sqrt{x} \\ CV = \frac{1}{\sqrt{x}} \qquad Formula 1$$

The coefficient of variation can relatively express the level of variation, taking the size of the population into account. Hence, the coefficient of variation enables comparison in variation between two populations having different average values.

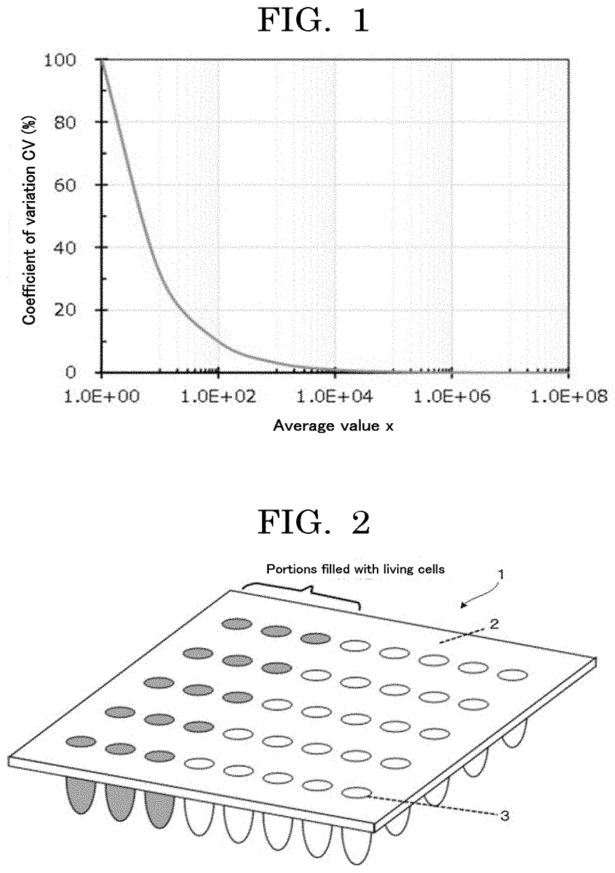

When the coefficient of variation (CV value) per average value x is calculated, the results are as presented in Table 1 and FIG. 1. The coefficient of variation (discharged cell number accuracy: the total of the numbers of cells contained in liquid droplets discharged from an inkjet head and located in a concave) can be obtained based on an average value x, with reference to the graph plotted in FIG. 1.

TABLE 1

| Average value x | Coefficient of variation CV |
|---|---|
| 1.00E+00 | 100.00% |
| 1.00E+01 | 31.62% |
| 1.00E+02 | 10.00% |
| 1.00E+03 | 3.16% |
| 1.00E+04 | 1.00% |
| 1.00E+05 | 0.32% |
| 1.00E+06 | 0.10% |
| 1.00E+07 | 0.03% |
| 1.00E+08 | 0.01% |

Examples of the method for calculating the cell discharging accuracy (coefficient of variation) include a method of counting the numbers of cells contained in the concaves of the cell contained container, calculating the average value x and the standard deviation s, and dividing the obtained standard deviation s by the obtained average value x.

The method for calculating the cell discharging accuracy (coefficient of variation) may also be estimation based on “uncertainty” representing variation in measurement results due to, for example, devices used for the measurement and operations.

“Uncertainty” is defined in ISO/IEC Guide 99:2007 [International Vocabulary of Metrology-Basics and general concepts and related terms (VIM)] as “a parameter that characterizes measurement result-incidental variation or dispersion of values rationally linkable to the measured quantity”.

Here, “values rationally linkable to the measured quantity” means candidates for the true value of the measured quantity. That is, uncertainty means information on the variation of the results of measurement due to operations and devices involved in production of a measurement target. With a greater uncertainty, a greater variation is predicted in the results of measurement.

For example, the uncertainty may be standard deviation obtained from the results of measurement for calculating variation in operations and devices involved in production, or a half value of a reliability level, which is expressed as a numerical range in which the true value is contained at a predetermined probability or higher.

The uncertainty may be calculated according to the methods based on, for example, Guide to the Expression of Uncertainty in Measurement (GUM:ISO/IEC Guide 98-3), and Japan Accreditation Board Note 10, Guideline on Uncertainty in Measurement in Test.

As the method for calculating the uncertainty, for example, there are two types of applicable methods: a type-A evaluation method using, for example, statistics of the measured values, and a type-B evaluation method using information on uncertainty obtained from, for example, calibration certificate, manufacturer's specification, and information open to the public.

All uncertainties due to factors such as operations and measurement can be expressed by the same reliability level, by conversion of the uncertainties to standard uncertainty. Standard uncertainty indicates variation in the average value of measured values.

In an example method for calculating the uncertainty, for example, factors that may cause uncertainties are extracted, and uncertainties (standard deviations) due to the respective factors are calculated. Then, the calculated uncertainties due to the respective factors are synthesized according to the sum-of-squares method, to calculate a synthesized standard uncertainty. In the calculation of the synthesized standard uncertainty, the sum-of-squares method is used. Therefore, a factor that causes a sufficiently small uncertainty can be ignored, among the factors that cause uncertainties. As the uncertainty, a coefficient of variation (CV) obtained by dividing a synthesized standard uncertainty by an expected value may also be used.

In the case of producing a cell contained container by dispensing cells while counting the number of cells in a cell suspension containing the cells, examples of the factors that may cause uncertainties or the factors that may cause uncertainty in the number of cells in each concave include the unit configured to locate cells in the concave, and the frequency at which located cells are located at an appropriate position in the concave.

Examples of the factors due to the unit configured to locate cells in the concave when the unit is based on an inkjet method described below include the number of cells to be contained in a liquid droplet when the liquid droplet is formed by discharging a cell suspension by an inkjet method and dispersibility of the cell suspension.

Cells located in a concave at a certain discharging accuracy adhere to the bottom of the concave and undergo morphological change while the cells interact with each other. It is known that cells typically express intrinsic functions when the cells have been left to stand still in an environment close to in vivo for a certain time before a testing step, and hence a culturing step of 24 hours or a longer period is needed. Particularly, in the case of discharging differentiating pluripotent stem cells, it is desirable to perform the testing step after the cells have fully differentiated, and hence a culturing period of about from three days through one month may sometimes be needed.

That is, it is obvious that a filling accuracy expressing variation in the number of cells present in a concave in the testing step has a value greater than the discharging accuracy due to influences of, for example, variation in the adhering function of the cells, variation in the intercellular distance, variation in the interference with the base material, and variation due to the environmental factors during culturing.

The filling accuracy in terms of the number of cells contained in a concave of the cell contained container of the present disclosure is preferably 30% or lower and more preferably 15% or lower. When the filling accuracy is 30% or lower, the cell contained container can be applied to a wide variety of tests including a test in which the number of cells contained in the cell-contained container is poorly influential to the results and a test in which stringency of the number of cells contained in the cell contained container is needed.

### <Other Members>

The other members are not particularly limited and may be appropriately selected depending on the intended purpose. Examples of the other members include an identifier unit, a memory unit, a cap member configured to cap a plurality of concaves, and a covering sheet.

### <<Identifier Unit>>

An identifier unit is a unit provided over the cell contained container of the present disclosure and configured to enable identifying the cell contained container.

It is preferable that the identifier unit be at least any one selected from the group consisting of an identifier section and an identifier indication.

The identifier section is not particularly limited and may be appropriately selected depending on the intended purpose. Examples of the identifier section include a memory, an IC chip, a barcode, a QR code (registered trademark), a Radio Frequency Identifier (RFID), color coding, and printing. Among these identifier sections, RFID that enables association by wireless communication is preferable for mass production of cell contained containers. Also when the cell contained container is inserted in an analyzing device, RFID is preferable because association by wireless communication is available.

It is preferable that the identifier indication be at least any one selected from the group consisting of letter, symbol, graphic, and color. Among these identifier indications, number is particularly preferable. Identifier indications are preferable because identifier indications can be generated at lower costs than identifier sections, there is no need for a reading device configured to read information on the identifier sections, and the identifier indications can be identified visually.

The position at which the identifier unit is provided is not particularly limited and may be appropriately selected depending on the intended purpose. It is preferable to provide the identifier unit at a portion other than within a concave over the container, and at a portion other than the external circumference of the concave.

The number of identifier units is not particularly limited and may be appropriately selected depending on the intended purpose.

Examples of the method for writing identification information in the identifier section include manual input and a method using a writing device.

Examples of the method for writing the identifier indication over the container include a method of directly printing the identifier indication over the container, and a method of pasting an identifier indication-printed seal over the container.

The identification information in the identifier section can be read by a built-in reading mechanism provided in an analyzing device when the container is attached in the analyzing device. It is also possible to use a reading device provided outside the analyzing device.

The identifier indication can be read visually or by a build-in reading mechanism provided in an analyzing device when the container is attached in the analyzing device. It is also possible to use a reading device provided outside the analyzing device.

### <<Memory Unit>>

The memory unit is a unit configured to store information on the cell contained container and information on cells contained in the concaves, at a portion other than a measurement region of the cell contained container of the present disclosure. The measurement region of the container refers to the portions corresponding to the concaves (wells) in which a measurement target can be contained (also including the gap between concaves when the container includes a plurality of concaves).

The information on the cell contained container refers to information on the members constituting the cell contained container. Examples of the information include the kind of the container, the kind of a liquid applied in the concaves, the kind of the cell adhesive material, the measurement date and time, and the person in charge of measurement.

Examples of the information on cells contained in the concaves include the kind of the cells, the differentiation history of the cells, the origin (source) of the cells, manufacturer, manufacturing lot number, results of analyses (for example, activity value and emission intensity), a counting result of the number of cells in a liquid droplet formed when filling cells in a concave, the number of cells in a concave (a counted, known number), the cell survival rate in a concave, information on the positions of concaves in which cells are contained among a plurality of concaves, a cell filling accuracy in the cell contained container, and information on certainty (or uncertainty) of the number (known number) of cells.

For example, a counting result of the number of cells in a liquid droplet formed when filling cells in a concave and the number of cells (a counted, known number) can be measured by observation performed from the bottom of the concave immediately after location, or by a liquid droplet discharging/counting device described below.

Examples of the memory unit include a memory, a hard disk drive, a solid-state drive, and an IC chip. The memory unit may be provided in a server or in a personal computer.

The portion other than the measurement region of the container may be inside of the container or outside of the container, so long as the portion is a portion other than the region in which measurement is performed.

It is preferable that the memory unit be provided attachably to and detachably from the container. As a method for attaching or detaching the memory unit, a perforation may be provided at the boundary between the container and the memory unit, in order that the memory unit can be separated along the perforation as needed. This makes it possible to separate the memory unit from the container when inserting the container in an analyzing device and to insert the separated memory unit in a reading device, in order that the container and the memory unit can be associated with each other.

It is preferable that the memory unit be attached to the container by a joining member. This makes it possible to prevent the memory unit from being lost. Examples of the joining member include a string and a magnet.

Example of the method for writing the information on the cell-contained container and the information on the cells contained in the concaves in the memory unit include manual input, a method of directly writing data through a liquid droplet discharging/counting device configured to count the number of cells, transfer of data stored in a server, and transfer of data stored in a cloud system. Among these methods, the method of directly writing data through a liquid droplet discharging/counting device is preferable.

As the liquid droplet discharging/counting device, for example, the specification of Japanese Unexamined Patent Application Publication No. 2016-12260 and the specification of Japanese Unexamined Patent Application Publication No. 2016-132021 may be referenced. The liquid droplet discharging/counting device includes a cell number counting unit configured to discharge a cell suspension obtained by suspending cells in a liquid in the form of a liquid droplet and count the number of cells contained in the liquid droplet with a sensor while the discharged liquid droplet is flying before landing in a concave. In combination, the liquid droplet discharging/counting device also includes a cell number counting unit configured to count the number of cells landed in a concave with a sensor.

The operational method of a liquid droplet discharging unit of the liquid droplet discharging/counting device is not particularly limited and may be appropriately selected depending on the intended purpose. Examples of the operational method include inkjet heads based on, for example, a piezoelectric pressure applying method using a piezoelectric element, a thermal method using a heater, an electrostatic method of applying a tensile force to a liquid by an electrostatic attractive force.

The information stored in the memory unit may be read by an external information reading device, or may be read by a built-in reading mechanism provided in an analyzing device when the container is attached in the analyzing device.

In order to associate the identifier unit and the memory unit with each other, when the identifier unit is the identifier indication, a method of storing the same identifier indication as the identifier unit also in the memory unit is employed. Examples of the method for storing the identifier indication also in the memory unit include a method of directly printing the identifier indication and a method of pasting a seal on which the identifier indication is depicted.

On the other hand, when the identifier unit is the identifier section, association is done by storing the identification information in the identifier section in the memory unit. Examples of the method for storing the information in the identifier section in the memory unit include manual input and writing by a writing device.

The identification information in the identifier section as the identifier unit, read when the container is attached in an analyzing device may be checked against the information on the container, stored in the memory unit. This makes it possible to confirm whether association between the identifier unit and the memory unit is correct.

The cell contained container of the present disclosure includes at least two concaves, where the concaves contain cells, the number of kinds of the cells is at least two with respect to the container, and the shortest distance between centers of most closely adjacent two concaves of the concaves is 5.0 mm or less. Hence, because a plurality of kinds of cells are contained in a small region, an evaluation test using cells can be efficiently conducted with only one container. Moreover, the amount of a reagent used for an evaluation test using cells can be saved.

Because having the features described above, the cell contained container of the present disclosure can be suitably used in a test for evaluating medical efficacy or toxicity using cells.

The reagent evaluated in terms of medical efficacy is not particularly limited and may be appropriately selected depending on the intended purpose. Examples of the reagent include oxazolone, benzoquinone, 2,4-dinitrochlorobenzine, 4-phenylenediamine, glutaraldehyde, benzoyl peroxide, 4-methylaminophenol sulfate, formaldehyde, cinnamaldehyde, ethylenediamine, 2-hydroxyethyl acrylate, isoeugenol, nickel sulfate (II), benzylideneacetone, methyl 2-nonynoate, benzyl salicylate, diethylenetriamine, thioglycerol, 2-mercaptobenzothiazole, phenyl acetoaldehyde, hexyl cinnamaldehyde, dihydroeugenol, citral, resorcinol, phenyl benzoate, eugenol, abietic acid, ethyl aminobenzoate, benzyl cinnamate, cinnamyl alcohol, hydroxycitronellal, imidazolidinyl urea, butyl glycidyl ether, ethylene glycol dimethacrylate, glyoxal, and 4-nitrobenzyl bromide.

The reagent evaluated in terms of toxicity is not particularly limited and may be appropriately selected depending on the intended purpose. Examples of the reagent include zinc chloride, 1-butanol, benzoic acid, ethyl vanillin, 4-hydroxybenzoic acid, sulfanilic acid, tartaric acid, methyl salicylate, salicylic acid, sodium lauryl sulfate, lactic acid, benzyl alcohol, dextran, diethyl phthalate, glycerol, propyl paraben, Tween 80, dimethyl isophthalate, phenol, chlorobenzene, sulfanilamide, and octanoic acid.

The cell contained container of the present disclosure can be widely used in, for example, biotechnology-related industries, life science industries, and health care industries.

The cell contained container of the present disclosure will be described in detail with reference to the drawings. The same constituting elements will be denoted by the same reference numerals throughout the drawings, and redundant description about the same constituting elements may be skipped. For example, the number, the position, and the shape of the constituting members described below are not limited to the present embodiment, but may be set to, for example, the number, the position, and the shape suitable for carrying out the present disclosure.

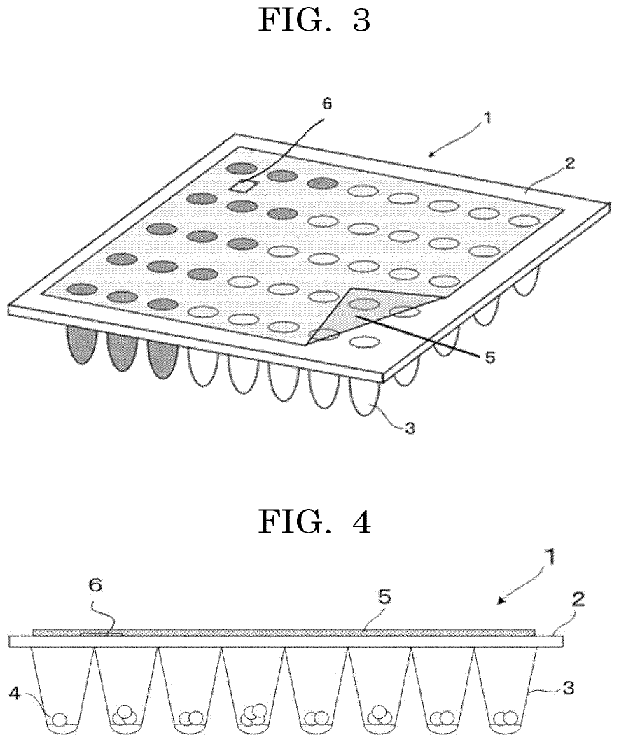

FIG. 2 is a perspective view illustrating an example of the cell contained container of the present disclosure. In a cell contained container 1, a plurality of concaves 3 are provided in a container 2, and cells 4 are filled in the concaves 3 in desired numbers. The reference numeral 5 in FIG. 3 and FIG. 4 denotes a sealing member.

For example, as illustrated in FIG. 3 and FIG. 4, an IC chip or a barcode (identifier unit 6) storing the information on the cells 4 filled in each concave 3 and the uncertainty (or certainty) of the number of cells, or information related with these kinds of information is placed at a position that is between the sealing member 5 and the container 2 and does not overlap the openings of the concaves. This is suitable for preventing, for example, unintentional alteration of the identifier unit 6.

With the identifier unit, the cell contained container can be distinguished from a common well plate that does not have an identifier unit. Therefore, confusion or mistake can be prevented.

### (Cell Contained Container Producing Method)

In a cell contained container producing method of the present disclosure, dispensing of a cell suspension containing cells into the at least two concaves includes a step of performing dispensing by an inkjet method.

By employing the cell contained container producing method of the present disclosure, it is possible to fill a desired number of cells in a concave at a predetermined position and suppress the volume of the liquid needed to fill the cells. This makes it possible to suppress influence that may be given on the experiment system of the user by the reagent contained in the cell contained container.

In the cell contained container producing method of the present disclosure, for example, dispensing of the cell suspension may only include performing dispensing by an inkjet method, or may include dispensing by an inkjet method after dispensing by a dispenser.

First, a case of dispensing the cell suspension only by dispensing by an inkjet method will be described below.

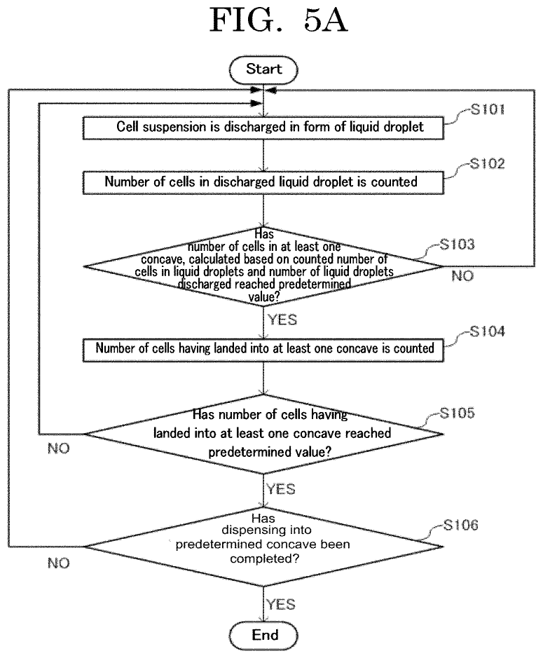

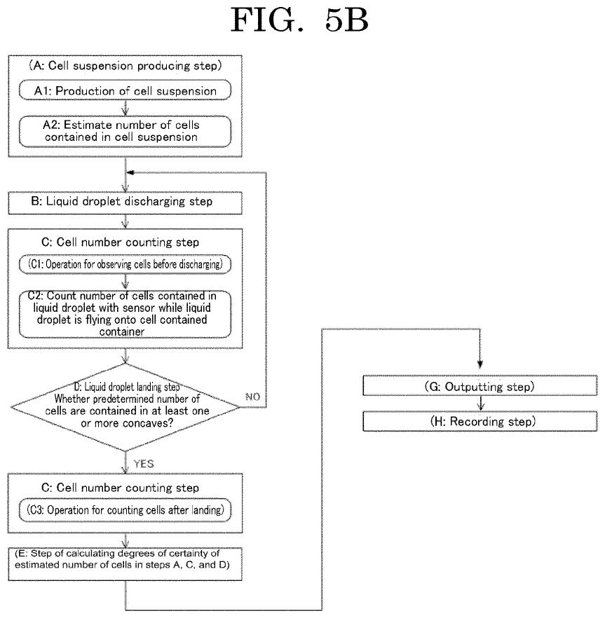

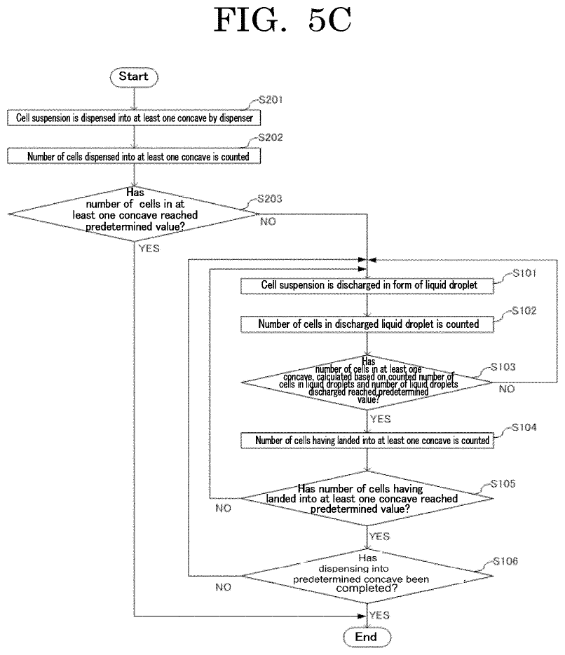

A flowchart of an example of the cell contained container producing method of the present disclosure is illustrated in FIG. 5A and FIG. 5C, and each step will be described.

FIG. 5A is a flowchart illustrating an example of a cell contained container producing method of the present disclosure.

The process flow of returning to the step S101 when the determination in the step S103 is “NO” and the process flow of returning to the step S101 when the determination in the step S105 is “NO” are regarded as a “correction process” for correcting the number of cells in a dispensing target concave to a predetermined value when the number of cells in the concave has not reached the predetermined value.

When there are a plurality of concaves, the “correction process” of returning to the step S101 when the determination in the step S105 is “NO” may be performed collectively for these concaves after the step S101 to the step S104 have been performed.

The step S106 is a process performed for at least one concave, when there are a plurality of concaves and dispensing is performed into the at least one concave in a manner that the number of cells in the concave reaches a predetermined value.

In the step S101, the cell suspension is discharged in the form of a liquid droplet.

In the step S102, the number of cells in the liquid droplet discharged is counted.

In the step S103, it is determined whether the number of cells in at least one concave, calculated based on the counted number of cells in liquid droplets and the number of liquid droplets, has reached a predetermined value.

Examples of the method for counting the number of cells in a liquid droplet include an optical detection method and an electric or electromagnetic detection method described below.

In the step S103, it is determined whether cells have been dispensed into at least one concave by a predetermined number (set number), based on counting of the number of cells in a liquid droplet and on the number of liquid droplets discharged into the at least one concave. That is, the number of cells dispensed into the one concave is counted (estimated) based on the number of cells contained in liquid droplets discharged into the one concave and the number of liquid droplets discharged into the one concave. In the step S103, the flow is moved to the step S104 when it is determined that cells have been dispensed into the at least one concave by a predetermined number, whereas the flow is moved to the step S101 when it is determined that cells have not been dispensed into the at least one concave by a predetermined number.

In the step S104, the number of cells that have landed in at least one concave is counted.

Examples of the method for counting the number of cells that have landed in at least one concave include an optical detection method and an electric or electromagnetic detection method described below.

In the step S105, it is determined whether the number of cells that have landed in at least one concave has reached a predetermined value.

In the step S105, the flow is moved to the step S106 when it is determined that the number of cells that have landed in at least one concave (and are actually present in the concave), counted in the step S104, has reached the predetermined value (set number), whereas the flow is moved to the step S101 when it is determined that the number of cells that have landed in at least one concave (and are actually present in the concave), counted in the step S104, has not reached the predetermined value (set number). When the flow is moved to the step S101, discharging of the cell suspension is performed by an inkjet method, to perform an operation of correcting the number of cells in the concave.

In the step S106, it is determined whether dispensing into a predetermined concave has been completed. A predetermined concave refers to an arbitrarily selected concave of a container including at least one concave.

In the step S106, the flow is moved to the step S101 when dispensing into a predetermined concave has not been completed, to perform remaining discharging of liquid droplets into the predetermined concave, whereas the flow is terminated when dispensing into the predetermined concave has been completed.

In the case of performing dispensing only by a dispenser, a dead volume tends to occur because an excessive cell suspension is needed in order to prevent bubbles from mixing into a concave during a sucking operation. Moreover, in the case of performing dispensing only by a dispenser, the amount of the liquid to be dispensed tends to be high.

Dispensing of the cell suspension only by dispensing by an inkjet method makes it possible to suppress the amount of the liquid to be dispensed and the dead volume. This eliminates the need for excessively preparing the cell suspension to be used.

As illustrated in FIG. 5B, the cell contained container producing method of the present disclosure includes B: a liquid droplet discharging step, C: a cell number counting step, and D: a liquid droplet landing step, and as needed, includes A: a cell suspension producing step, E: a step of calculating degrees of certainty of estimated numbers of cells in the steps A to D, G: an outputting step, and H: a recording step. As needed, the method may include A2: estimating the number of cells contained in the cell suspension in A: the cell suspension producing step, and C1: an operation for observing cells before discharging and C3: an operation for counting cells after landing in C: the cell number counting step.

### <Cell Suspension Producing Step>

The cell suspension producing step is a step of producing a cell suspension containing cells and a liquid.

The liquid means a liquid used for dispersing cells.

Suspension in the cell suspension means a state of cells being present dispersedly in the liquid.

Producing means a producing operation.

### —Cells—

The cells are the same as the cells usable in the cell contained container of the present disclosure. Hence, description on the cells will be skipped.

The concentration of the cells in the cell suspension is not particularly limited, may be appropriately selected depending on the intended purpose, and is preferably 5×10⁴ cells/mL or higher but 5×10⁸ cells/mL or lower, and more preferably 5×10⁵ cells/mL or higher but 5×10⁷ cells/mL or lower. When the number of cells is 5×10⁵ cells/mL or higher but 5×10⁸ cells/mL or lower, a liquid droplet discharged can contain cells without fail. The number of cells can be measured with an automated cell counter (product name: COUNTESS AUTOMATED CELL COUNTER, available from Invitrogen) in the same manner as measuring the volume average particle diameter.

### —Liquid—

The liquid is not particularly limited and may be appropriately selected depending on the intended purpose so long as the liquid can maintain an environment in which the cells can survive. Examples of the liquid include water, a broth, a separation liquid, a diluted solution, a buffer, an organic substance lysing liquid, an organic solvent, a polymer gel solution, a colloid dispersion liquid, an electrolyte aqueous solution, an inorganic salt aqueous solution, a metal aqueous solution, and a mixture liquid of these solutions. One of these liquids may be used alone or two or more of these liquids may be used in combination. Among these liquids, a culture medium or a buffer, or combined use of the liquid and a polymer gel solution is preferable, and a culture medium or a phosphate buffered saline (PBS) or a Tris-EDTA buffer (TE), or, as a polymer gel material for combined use, for example, collagen or IMATRIX 511 is more preferable.

### ——Additives——

Additives are not particularly limited and may be appropriately selected depending on the intended purpose so long as the additives can maintain an environment in which the cells can survive. Examples of the additives include a surfactant. One of these additives may be used alone or two or more of these additives may be used in combination.

### ———Surfactant———

A surfactant can prevent mutual aggregation of cells and improve continuous discharging stability.

The surfactant is not particularly limited and may be appropriately selected depending on the intended purpose. Examples of the surfactant include ionic surfactants and nonionic surfactants. One of these surfactants may be used alone or two or more of these surfactants may be used in combination. Among these surfactants, nonionic surfactants are preferable because proteins are neither modified nor deactivated by nonionic surfactants, although depending on the addition amount of the nonionic surfactants.

Examples of the ionic surfactants include fatty acid sodium, fatty acid potassium, alpha-sulfo fatty acid ester sodium, sodium straight-chain alkyl benzene sulfonate, alkyl sulfuric acid ester sodium, alkyl ether sulfuric acid ester sodium, and sodium alpha-olefin sulfonate. One of these ionic surfactants may be used alone or two or more of these ionic surfactants may be used in combination. Among these ionic surfactants, fatty acid sodium is preferable and sodium dodecyl sulfonate (SDS) is more preferable.

Examples of the nonionic surfactants include alkyl glycoside, alkyl polyoxyethylene ether (e.g., BRIJ series), octyl phenol ethoxylate (e.g., TRITON X series, IGEPAL CA series, NONIDET P series, and NIKKOL OP series), polysorbates (e.g., TWEEN series such as TWEEN 20), sorbitan fatty acid esters, polyoxyethylene fatty acid esters, alkyl maltoside, sucrose fatty acid esters, glycoside fatty acid esters, glycerin fatty acid esters, propylene glycol fatty acid esters, and fatty acid monoglyceride. One of these nonionic surfactants may be used alone or two or more of these nonionic surfactants may be used in combination. Among these nonionic surfactants, polysorbates are preferable.

The content of the surfactant is not particularly limited and may be appropriately selected depending on the intended purpose so long as an environment in which the cells can survive can be maintained, and is preferably 0.001% by mass or greater but 30% by mass or less relative to the total amount of the cell suspension. When the content of the surfactant is 0.001% by mass or greater, an effect of adding the surfactant can be obtained. When the content of the surfactant is 30% by mass or less, aggregation of cells can be suppressed.

### ——Other Materials——

Other materials are not particularly limited and may be appropriately selected depending on the intended purpose so long as an environment in which the cells can survive can be maintained. Examples of the other materials include a cross-linking agent, a pH adjustor, an antiseptic, an antioxidant, an osmotic pressure regulator, a humectant, and a dispersant.

### [Method for Dispersing Cells]

The method for dispersing the cells is not particularly limited and may be appropriately selected depending on the intended purpose so long as an environment in which the cells can survive can be maintained.

Examples of the method include dispersing by pipetting, a medium method such as a bead mill, an ultrasonic method such as an ultrasonic homogenizer, and a method using a pressure difference such as a French press. One of these methods may be used alone or two or more of these methods may be used in combination. Among these methods, pipetting is more preferable because pipetting has low damage on the cells. With the ultrasonic method and the medium method, a high crushing force may destroy cellular membranes or cell walls, and the medium may mix as contamination.

### [Method for Screening Cells]

The method for screening the cells is not particularly limited and may be appropriately selected depending on the intended purpose.

Examples of the method include screening by wet classification, a cell sorter, and a filter. One of these methods may be used alone or two or more of these methods may be used in combination. Among these methods, screening by a cell sorter and a filter is preferable because the method has low damage on the cells.

### <Liquid Droplet Discharging Step>

The liquid droplet discharging step is a step of discharging the cell suspension in the form of liquid droplets with a liquid droplet discharging unit into a container including at least two concaves.

A liquid droplet means a gathering of a liquid formed by a surface tension.

Discharging means making the cell suspension fly in the form of liquid droplets.

As a liquid droplet discharging unit, a unit (hereinafter may also be referred to as “discharging head” or “inkjet head”) configured to discharge the cell suspension in the form of liquid droplets, or an automated dispenser can be suitably used. Examples of the automated dispenser include BRAVO AUTOMATED LIQUID HANDLING PLATFORM available from Agilent Technologies Japan, Ltd.).

The discharging head (inkjet head) includes at least a liquid retaining unit configured to retain the cell suspension, a membranous member configured to apply vibration to the cell suspension and discharge liquid droplets, and an atmospherically exposing unit configured to expose the liquid retaining unit to the atmosphere.

As the liquid droplet discharging unit, it is preferable to provide at least two inkjet heads and use the at least two inkjet heads simultaneously or alternately.

Examples of the method for discharging the cell suspension in the form of liquid droplets include an on-demand method and a continuous method. Of these methods, in the case of the continuous method, there is a tendency that the dead volume of the cell suspension used is high, because of, for example, empty discharging until the discharging state becomes stable, adjustment of the amount of liquid droplets, and continued formation of liquid droplets even during transfer between the concaves. In the present disclosure, in terms of cell number adjustment, it is preferable to suppress influence due to the dead volume. Hence, of the two methods, the on-demand method is more preferable.

Examples of the on-demand method include a plurality of known methods such as a pressure applying method of applying a pressure to a liquid to discharge the liquid, a thermal method of discharging a liquid by film boiling due to heating, and an electrostatic method of drawing liquid droplets by electrostatic attraction to form liquid droplets. Among these methods, the pressure applying method is preferable for the reason described below.

In the electrostatic method, there is a need for disposing an electrode in a manner to face a discharging unit that is configured to retain the cell suspension and form liquid droplets. In the cell contained container producing method of the present disclosure, the cell contained container for receiving liquid droplets is disposed at the facing position. Hence, it is preferable not to provide an electrode, in order to increase the degree of latitude in the cell contained container configuration.

In the thermal method, there are a risk of local heating concentration that may affect the cells, which are a biomaterial, and a risk of kogation to the heater portion. Influences by heat depend on the components contained or the purpose for which the cell contained container is used. Therefore, there is no need for flatly rejecting the thermal method. However, the pressure applying method is preferable because the pressure applying method has a lower risk of kogation to the heater portion than the thermal method.

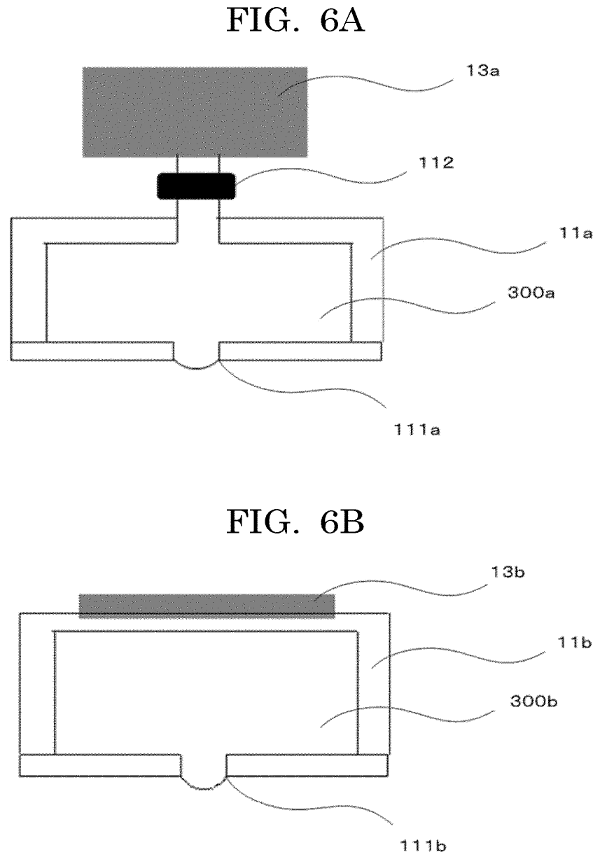

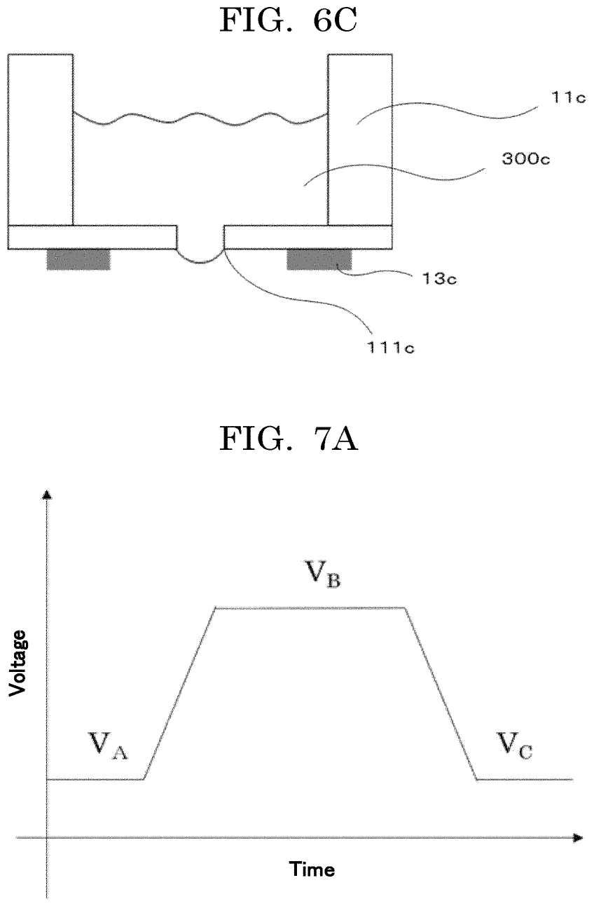

Examples of the pressure applying method include a method of applying a pressure to a liquid using a membranous member such as a piezo element, and a method of applying a pressure using a valve such as an electromagnetic valve. The configuration example of a liquid droplet generating device usable for discharging liquid droplets of the cell suspension is illustrated in FIG. 6A to FIG. 6C.

FIG. 6A is an exemplary diagram illustrating an example of an electromagnetic valve-type discharging head. The electromagnetic valve-type discharging head includes an electric motor 13a, an electromagnetic valve 112, a liquid retaining unit 11a, a cell suspension 300a, and a nozzle 111a.

As the electromagnetic valve-type discharging head, for example, a dispenser available from Tech Elan LLC can be suitably used.

FIG. 6B is an exemplary diagram illustrating an example of a piezo-type discharging head. The piezo-type discharging head includes a piezoelectric element 13b, a liquid retaining unit 11b, a cell suspension 300b, and a nozzle 111b.

As the piezo-type discharging head, for example, a single cell printer available from Cytena GmbH can be suitably used.

Any of these discharging heads may be used. However, the pressure applying method by the electromagnetic valve is not capable of forming liquid droplets at a high speed repeatedly. Therefore, it is preferable to use the piezo method in order to increase the throughput of producing the cell contained container. A piezo-type discharging head using a common piezoelectric element 13b may cause unevenness in the cell concentration due to settlement, or may have nozzle clogging.

Therefore, a more preferable configuration is the configuration illustrated in FIG. 6C. FIG. 6C is an exemplary diagram of a modified example of a piezo-type discharging head using the piezoelectric element illustrated in FIG. 6B. The discharging head of FIG. 6C includes a piezoelectric element 13c, a liquid retaining unit 11c, a cell suspension 300c, and a nozzle 111c.

In the discharging head of FIG. 6C, when a voltage is applied to the piezoelectric element 13c from an unillustrated control device, a compressive stress is applied in the horizontal direction of the drawing sheet. This can deform the membrane in the upward-downward direction of the drawing sheet. As a result, liquid droplets are formed while the cell suspension 300c in the liquid retaining unit 11c is being stirred. This makes it possible to suppress nozzle clogging and form liquid droplets at a high speed repeatedly.

Examples of any other method than the on-demand method include a continuous method for continuously forming liquid droplets. When pushing out liquid droplets by pressurization, the continuous method applies regular fluctuations using a piezoelectric element or a heater, to make it possible to continuously form minute liquid droplets. Further, the continuous method can select whether to land a flying liquid droplet into a concave or to recover the liquid droplet in a recovery unit, by controlling the discharging direction of the liquid droplet with voltage application. Such a method is employed in a cell sorter or a flow cytometer. For example, a device named: CELL SORTER SH800 available from Sony Corporation can be used.

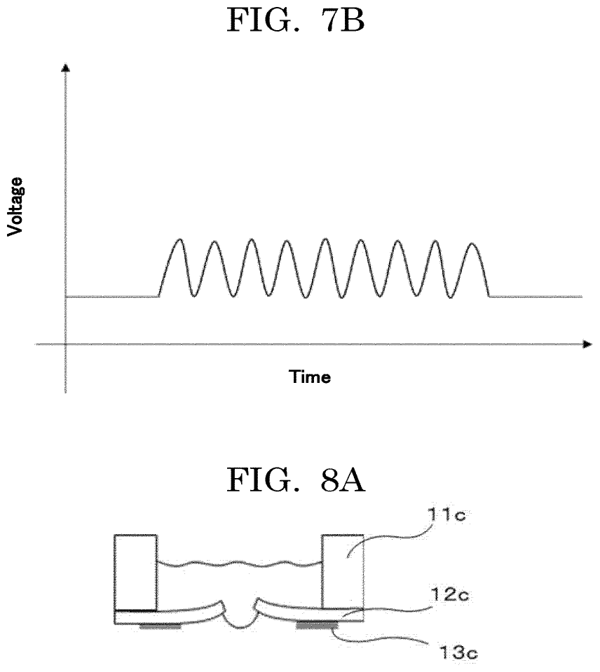

FIG. 7A is an exemplary graph plotting an example of a voltage applied to a piezoelectric element. FIG. 7B is an exemplary graph plotting another example of a voltage applied to a piezoelectric element. FIG. 7A plots a drive voltage for forming liquid droplets. Depending on the high or low level of the voltage (V_{A}, V_{B}, and V_{C}), it is possible to form liquid droplets. FIG. 7B plots a voltage for stirring the cell suspension without discharging liquid droplets.

During a period in which liquid droplets are not discharged, inputting a plurality of pulses that are not high enough to discharge liquid droplets enables the cell suspension in the liquid chamber to be stirred, making it possible to suppress occurrence of a concentration distribution due to settlement of the cells.

The liquid droplet forming operation of the discharging head that can be used in the present disclosure will be described below.

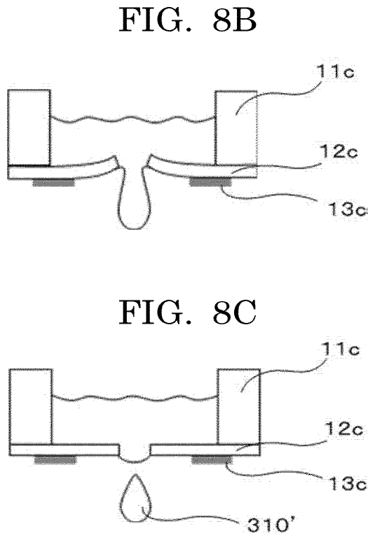

The discharging head can discharge liquid droplets with application of a pulsed voltage to the upper and lower electrodes formed on the piezoelectric element. FIG. 8A to FIG. 8C are exemplary diagrams illustrating liquid droplet states at the respective timings. In FIG. 8A, first, upon application of a voltage to the piezoelectric element 13c, a membrane 12c abruptly deforms to cause a high pressure between the cell suspension retained in the liquid retaining unit 11c and the membrane 12c. This pressure pushes out a liquid droplet outward through the nozzle portion. Next, as illustrated in FIG. 8B, for a period of time until when the pressure relaxes upward, the liquid is continuously pushed out through the nozzle portion, to grow the liquid droplet. Finally, as illustrated in FIG. 8C, when the membrane 12c returns to the original state, the liquid pressure about the interface between the cell suspension and the membrane 12c lowers, to form a liquid droplet 310′.

The container is not particularly limited so long as the container is a component commonly used in bio fields. Examples of the container include: plates provided with at least any one kind of sections selected from the group consisting of holes, concaves, and convexes; plates provided with no sections; and tubes. More specifically, examples of plates provided with sections include 24-well, 96-well, 384-well, and 1,536-well plates, examples of plates provided with no sections include glass slides, and examples of tubes include 8-series PCR tubes and PCR tubes used alone.

The concave is not particularly limited and may be appropriately selected depending on the intended purpose, so long as the concave has a specific region capable of containing a cell. Examples of the concave include sections provided on a cell contained container, and regions provided on a cell contained container other than sections. More specific examples of the concave include wells in a 24-well, 96-well, 384-well, and 1,536-well plates.

The number of concaves in the container is not particularly limited and may be appropriately selected depending on the intended purpose. The number of concaves may be a single number or a plural number. Here, the number of concaves means the number of sections in the case of a plate provided with sections, means the number of specific regions capable of containing a cell in the case of a plate provided with no sections, and means the number of tubes in the case of a tube.

As a container with a plural number of concaves, it is preferable to use a container in which 24, 96, 384, 1,536, or such a number of concaves as commonly used in the industry are formed with dimensions commonly used in the industry.

In the present disclosure, a container may be referred to as plate. In the present disclosure, when a container is referred to as plate, the plate means at least any one container selected from the group consisting of a container including concaves and convexes and a container free of concaves and convexes.

The material of the container is not particularly limited and may be appropriately selected depending on the intended purpose. In consideration of a post-treatment, it is preferable to use a material that suppresses adhesion of cells and nucleic acids to wall surfaces.

As the container, it is preferable to use a container provided with a recognition unit allowing recognition of each container. As the recognition unit, for example, a barcode, a QR code (registered trademark), a Radio Frequency Identifier (hereinafter may also be referred to as “RFID”) can be used. In mass production of cell contained containers, RFID that can be used wirelessly is preferable.

As the container, it is preferable to use a 1-well microtube, an 8-series tube, a 96-well plate, a 384-well plate, and a 1,536-well plate. When the number of concaves are a plural number, it is possible to dispense the same number of cells into the concaves of the container, or it is also possible to dispense numbers of cells of different levels into the concaves. There may be a concave in which no cells are contained.

### <Cell Number Counting Step>

The cell number counting step is a step of counting a number of cells contained in the liquid droplet with a plurality of sensors from two or more directions while the liquid droplet is flying into the concave. A sensor means a device configured to, by utilizing some scientific principles, change mechanical, electromagnetic, thermal, acoustic, or chemical properties of natural phenomena or artificial products or spatial information/temporal information indicated by these properties into signals, which are a different medium easily handleable by humans or machines.

Counting means counting of numbers.

The cell number counting step is not particularly limited and may be appropriately selected depending on the intended purpose, so long as the cell number counting step counts the number of cells contained in the liquid droplet with a sensor while the liquid droplet is flying into the concave. The cell number counting step may include an operation for observing cells before discharging and an operation for counting cells after landing.

As a method for counting the number of cells contained in the liquid droplet while the liquid droplet is flying into the concave, it is preferable to count the number of cells in the liquid droplet at a timing at which the liquid droplet is at a position that is immediately above a desired concave in the container and at which the liquid droplet is predicted to enter the concave without fail. When the concaves have openings, the timing means a timing at which the liquid droplet is at a position immediately above the opening of a desired concave.

Examples of the method for counting the number of cells in the liquid droplet include an optical detection method and an electric or electromagnetic detection method.

### —Optical Detection Method—

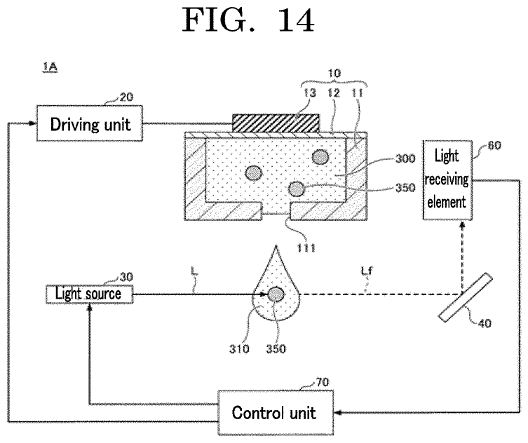

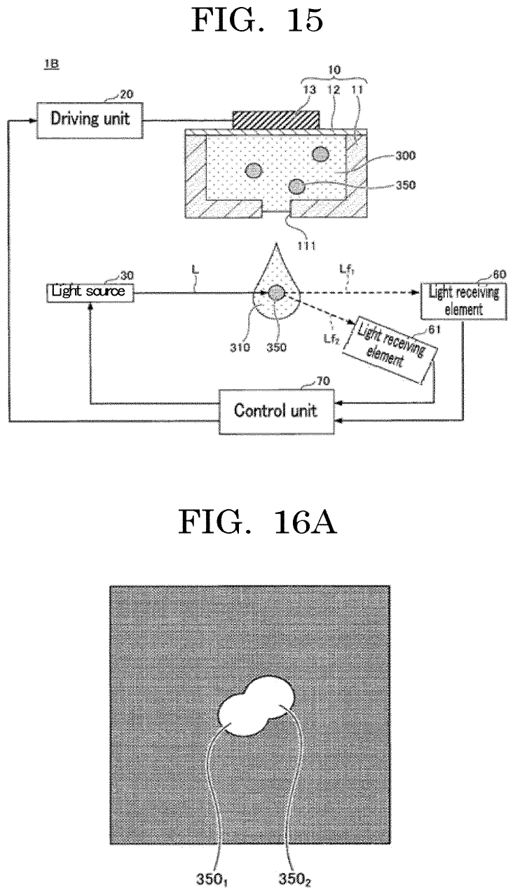

With reference to FIG. 10, FIG. 14, and FIG. 15, an optical detection method will be described below.

FIG. 10 is an exemplary diagram illustrating an example of a liquid droplet forming device. FIG. 14 and FIG. 15 are exemplary diagrams illustrating other examples of the liquid droplet forming device. As illustrated in FIG. 10, the liquid droplet forming device 1 includes a discharging head (liquid droplet discharging unit) 10, a driving unit 20, a light source 30, a light receiving element 60, and a control unit 70.

In FIG. 10, a liquid obtained by dispersing cells in a predetermined solution after fluorescently staining the cells with a specific pigment is used as the cell suspension. Cells are counted by irradiating the liquid droplets formed by the discharging head with light having a specific wavelength and emitted from the light source and detecting fluorescence emitted by the cells with the light receiving element. Here, autofluorescence emitted by molecules originally contained in the cells may be utilized, in addition to the method of staining the cells with a fluorescent pigment. Alternatively, genes for producing fluorescent proteins (for example, GFP (Green Fluorescent Proteins)) may be previously introduced into the cells, in order that the cells may emit fluorescence.

Irradiation of a target with light means application of light to the target.

The discharging head 10 includes a liquid retaining unit 11, a membrane 12, and a driving element 13 and can discharge a cell suspension 300 suspending fluorescent-stained cells 350 in the form of liquid droplets.

The liquid retaining unit 11 is a liquid retaining portion configured to retain the cell suspension 300 suspending the fluorescent-stained cells 350. A nozzle 111, which is a through hole, is formed in the lower surface of the liquid retaining unit 11. The liquid retaining unit 11 may be formed of, for example, a metal, silicon, or a ceramic. Examples of the fluorescent-stained cells 350 include inorganic particles and organic polymer particles stained with a fluorescent pigment.

The membrane 12 is a membranous member secured on the upper end portion of the liquid retaining unit 11. The planar shape of the membrane 12 may be, for example, a circular shape, but may also be, for example, an elliptic shape or a quadrangular shape.

The driving element 13 is provided on the upper surface of the membrane 12. The shape of the driving element 13 may be designed to match the shape of the membrane 12. For example, when the planar shape of the membrane 12 is a circular shape, it is preferable to provide a circular driving element 13.

The membrane 12 can be vibrated by supplying a driving signal to the driving element 13 from a driving unit 20. The vibration of the membrane 12 can cause a liquid droplet 310 containing the fluorescent-stained cells 350 to be discharged through the nozzle 111.

When a piezoelectric element is used as the driving element 13, for example, the driving element 13 may have a structure obtained by providing the upper surface and the lower surface of the piezoelectric material with electrodes across which a voltage is to be applied. In this case, when the driving unit 20 applies a voltage across the upper and lower electrodes of the piezoelectric element, a compressive stress is applied in the horizontal direction of the drawing sheet, making it possible for the membrane 12 to vibrate in the upward-downward direction of the drawing sheet. As the piezoelectric material, for example, lead zirconate titanate (PZT) may be used. In addition, various piezoelectric materials can be used, such as bismuth iron oxide, metal niobate, barium titanate, or materials obtained by adding metals or different oxides to these materials.

The light source 30 is configured to irradiate a flying liquid droplet 310 with light L. A flying state means a state from when the liquid is droplet 310 is discharged from a liquid droplet discharging unit 10 until when the liquid droplet 310 lands on the landing target. A flying liquid droplet 310 has an approximately spherical shape at the position at which the liquid droplet 310 is irradiated with the light L. The beam shape of the light L is an approximately circular shape.

It is preferable that the beam diameter of the light L be from about 10 times through 100 times as great as the diameter of the liquid droplet 310. This is for ensuring that the liquid droplet 310 is irradiated with the light L from the light source 30 without fail even when the position of the liquid droplet 310 fluctuates.

However, it is not preferable if the beam diameter of the light L is much greater than 100 times as great as the diameter of the liquid droplet 310. This is because the energy density of the light with which the liquid droplet 310 is irradiated is reduced, to lower the light volume of fluorescence Lf to be emitted upon the light L serving as excitation light, making it difficult for the light receiving element 60 to detect the fluorescence Lf.

It is preferable that the light L emitted by the light source 30 be pulse light. It is preferable to use, for example, a solid-state laser, a semiconductor laser, and a dye laser. When the light L is pulse light, the pulse width is preferably 10 microseconds or less and more preferably 1 microsecond or less. The energy per unit pulse is preferably roughly 0.1 microjoules or higher and more preferably 1 microjoule or higher, although significantly depending on the optical system such as presence or absence of light condensation.

The light receiving element 60 is configured to receive fluorescence Lf emitted by the fluorescent-stained cell 350 upon absorption of the light L as excitation light, when the fluorescent-stained cell 350 is contained in a flying liquid droplet 310. Because the fluorescence Lf is emitted to all directions from the fluorescent-stained cell 350, the light receiving element 60 can be disposed at an arbitrary position at which the fluorescence Lf is receivable. Here, in order to improve contrast, it is preferable to dispose the light receiving element 60 at a position at which direct incidence of the light L emitted by the light source 30 to the light receiving element 60 does not occur.

The light receiving element 60 is not particularly limited and may be appropriately selected depending on the intended purpose so long as the light receiving element 60 is an element capable of receiving the fluorescence Lf emitted by the fluorescent-stained cell 350. An optical sensor configured to receive fluorescence from a cell in a liquid droplet when the liquid droplet is irradiated with light having a specific wavelength is preferable. Examples of the light receiving element 60 include one-dimensional elements such as a photodiode and a photosensor. When high-sensitivity measurement is needed, it is preferable to use a photomultiplier tube and an Avalanche photodiode. As the light receiving element 60, two-dimensional elements such as a CCD (Charge Coupled Device), a CMOS (Complementary Metal Oxide Semiconductor), and a gate CCD may be used.

The fluorescence Lf emitted by the fluorescent-stained cell 350 is weaker than the light L emitted by the light source 30. Therefore, a filter configured to attenuate the wavelength range of the light L may be installed at a preceding stage (light receiving surface side) of the light receiving element 60. This enables the light receiving element 60 to obtain an extremely highly contrastive image of the fluorescent-stained cell 350. As the filter, for example, a notch filter configured to attenuate a specific wavelength range including the wavelength of the light L may be used.

As described above, it is preferable that the light L emitted by the light source 30 be pulse light. The light L emitted by the light source 30 may be continuously oscillating light. In this case, it is preferable to control the light receiving element 60 to be capable of receiving light at a timing at which a flying liquid droplet 310 is irradiated with the continuously oscillating light, to make the light receiving element 60 receive the fluorescence Lf.

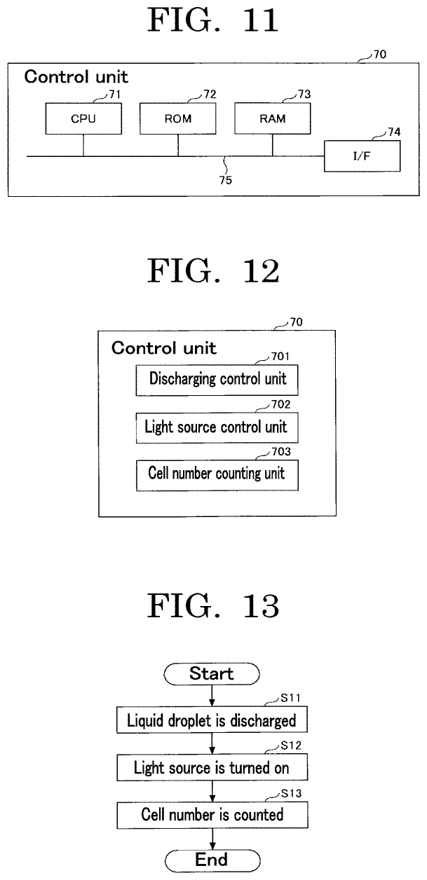

The control unit 70 has a function of controlling the driving unit 20 and the light source 30. The control unit 70 also has a function of obtaining information that is based on the light volume received by the light receiving element 60 and counting the number of fluorescent-stained cells 350 contained in the liquid droplet 310 (the case where the number is zero is also included). With reference to FIG. 11 to FIG. 13, an operation of the liquid droplet forming device 1 including an operation of the control unit 70 will be described below.

FIG. 11 is a diagram illustrating hardware blocks of the control unit of FIG. 10. FIG. 12 is a diagram illustrating functional blocks of the control unit of FIG. 10. FIG. 13 is a flowchart illustrating an example of the operation of the liquid droplet forming device.

As illustrated in FIG. 11, the control unit 70 includes a CPU 71, a ROM 72, a RAM 73, an I/F 74, and a bus line 75. The CPU 71, the ROM 72, the RAM 73, and the I/F 74 are coupled to one another via the bus line 75.

The CPU 71 is configured to control various functions of the control unit 70. The ROM 72 serving as a memory unit is configured to store programs to be executed by the CPU 71 for controlling the various functions of the control unit 70 and various information. The RAM 73 serving as a memory unit is configured to be used as, for example, the work area of the CPU 71. The RAM 73 is also configured to be capable of storing predetermined information for a temporary period of time. The I/F 74 is an interface configured to couple the liquid droplet forming device 1 to, for example, another device. The liquid droplet forming device 1 may be coupled to, for example, an external network via the I/F 74.

As illustrated in FIG. 12, the control unit 70 includes a discharging control unit 701, a light source control unit 702, and a cell number counting unit (cell number sensing unit) 703 as functional blocks. With reference to FIG. 12 and FIG. 13, particle number counting by the liquid droplet forming device 1 will be described. In the step S11, the discharging control unit 701 of the control unit 70 outputs an instruction for discharging to the driving unit 20. Upon reception of the instruction for discharging from the discharging control unit 701, the driving unit 20 supplies a driving signal to the driving element 13 to vibrate the membrane 12. The vibration of the membrane 12 causes a liquid droplet 310 containing a fluorescent-stained cell 350 to be discharged through the nozzle 111.

Next, in the step S12, the light source control unit 702 of the control unit 70 outputs an instruction for lighting to the light source 30 in synchronization with the discharging of the liquid droplet 310 (in synchronization with a driving signal supplied by the driving unit 20 to the liquid droplet discharging unit 10). In accordance with this instruction, the light source 30 is turned on to irradiate the flying liquid droplet 310 with the light L.

Here, the light is emitted by the light source 30, not in synchronization with discharging of the liquid droplet 310 by the liquid droplet discharging unit 10 (supplying of the driving signal to the liquid droplet discharging unit 10 by the driving unit 20), but in synchronization with the timing at which the liquid droplet 310 has come flying to a predetermined position in order for the liquid droplet 310 to be irradiated with the light L. That is, the light source control unit 702 controls the light source 30 to emit light at a predetermined period of time of delay from the discharging of the liquid droplet 310 by the liquid droplet discharging unit 10 (from the driving signal supplied by the driving unit 20 to the liquid droplet discharging unit 10).

For example, the speed v of the liquid droplet 310 to be discharged when the driving signal is supplied to the liquid droplet discharging unit 10 may be measured beforehand. Based on the measured speed v, the time t taken from when the liquid droplet 310 is discharged until when the liquid droplet 310 reaches the predetermined position may be calculated, in order that the timing of light irradiation by the light source 30 may be delayed from the timing at which the driving signal is supplied to the liquid droplet discharging unit 10 by the period of time of t. This enables a good control on light emission, and can ensure that the liquid droplet 310 is irradiated with the light from the light source 30 without fail.

Next, in the step S13, the cell number counting unit 703 of the control unit 70 counts the number of fluorescent-stained cells 350 contained in the liquid droplet 310 (the case where the number is zero is also included) based on information from the light receiving element 60. The information from the light receiving element 60 indicates the luminance (light volume) and the area value of the fluorescent-stained cell 350.

The cell number counting unit 703 can count the number of fluorescent-stained cells 350 by, for example, comparing the light volume received by the light receiving element 60 with a predetermined threshold. In this case, a one-dimensional element may be used or a two-dimensional element may be used as the light receiving element 60.

When a two-dimensional element is used as the light receiving element 60, the cell number counting unit 703 may use a method of performing image processing for calculating the luminance or the area of the fluorescent-stained cell 350 based on a two-dimensional image obtained from the light receiving element 60. In this case, the cell number counting unit 703 can count the number of fluorescent-stained cells 350 by calculating the luminance or the area value of the fluorescent-stained cell 350 by image processing and comparing the calculated luminance or area value with a predetermined threshold.

The fluorescent-stained cell 350 may be a cell or a stained cell. A stained cell means a cell stained with a fluorescent pigment or a cell that can express a fluorescent protein.

The fluorescent pigment for the stained cell is not particularly limited and may be appropriately selected depending on the intended purpose. Examples of the fluorescent pigment include fluoresceins, rhodamines, coumarins, pyrenes, cyanines, and azo pigments. One of these fluorescent pigments may be used alone or two or more of these fluorescent pigments may be used in combination. Among these fluorescent pigments, eosin, Evans blue, trypan blue, rhodamine 6G, rhodamine B, and Rhodamine 123 are more preferable.

Examples of the fluorescent protein include Sirius, EBFP, ECFP, mTurquoise, TagCFP, AmCyan, mTFP1, MidoriishiCyan, CFP, TurboGFP, AcGFP, TagGFP, Azami-Green, ZsGreen, EmGFP, EGFP, GFP2, HyPer, TagYFP, EYFP, Venus, YFP, PhiYFP, PhiYFP-m, TurboYFP, ZsYellow, mBanana, KusabiraOrange, mOrange, TurboRFP, DsRed-Express, DsRed2, TagRFP, DsRed-Monomer, AsRed2, mStrawberry, TurboFP602, mRFP1, JRed, KillerRed, mCherry, mPlum, PS-CFP, Dendra2, Kaede, EosFP, and KikumeGR. One of these fluorescent proteins may be used alone or two or more of these fluorescent proteins may be used in combination.

In this way, in the liquid droplet forming device 1, the driving unit 20 supplies a driving signal to the liquid droplet discharging unit 10 retaining the cell suspension 300 suspending fluorescent-stained cells 350 to cause the liquid droplet discharging unit 10 to discharge a liquid is droplet 310 containing the fluorescent-stained cell 350, and the flying liquid droplet 310 is irradiated with the light L from the light source 30. Then, the fluorescent-stained cell 350 contained in the flying liquid droplet 310 emits the fluorescence Lf upon the light L serving as excitation light, and the light receiving element 60 receives the fluorescence Lf. Then, the cell number counting unit 703 counts the number of fluorescent-stained cells 350 contained in the flying liquid droplet 310, based on information from the light receiving element 60.

That is, the liquid droplet forming device 1 is configured for on-the-spot actual observation of the number of fluorescent-stained cells 350 contained in the flying liquid droplet 310. This can realize a better accuracy than hitherto obtained, in counting the number of fluorescent-stained cells 350. Moreover, because the fluorescent-stained cell 350 contained in the flying liquid droplet 310 is irradiated with the light L and emits the fluorescence Lf that is to be received by the light receiving element 60, an image of the fluorescent-stained cell 350 can be obtained with a high contrast, and the frequency of occurrence of erroneous counting of the number of fluorescent-stained cells 350 can be reduced.

FIG. 14 is an exemplary diagram illustrating a modified example of the liquid droplet forming device of FIG. 10. As illustrated in FIG. 14, a liquid droplet forming device 1A is different from the liquid droplet forming device 1 (see FIG. 10) in that a mirror 40 is arranged at the preceding stage of the light receiving element 60. Description about components that are the same as in the embodiment already described may be skipped.

In the liquid droplet forming device 1A, arranging the mirror 40 at the perceiving stage of the light receiving element 60 can improve the degree of latitude in the layout of the light receiving element 60.

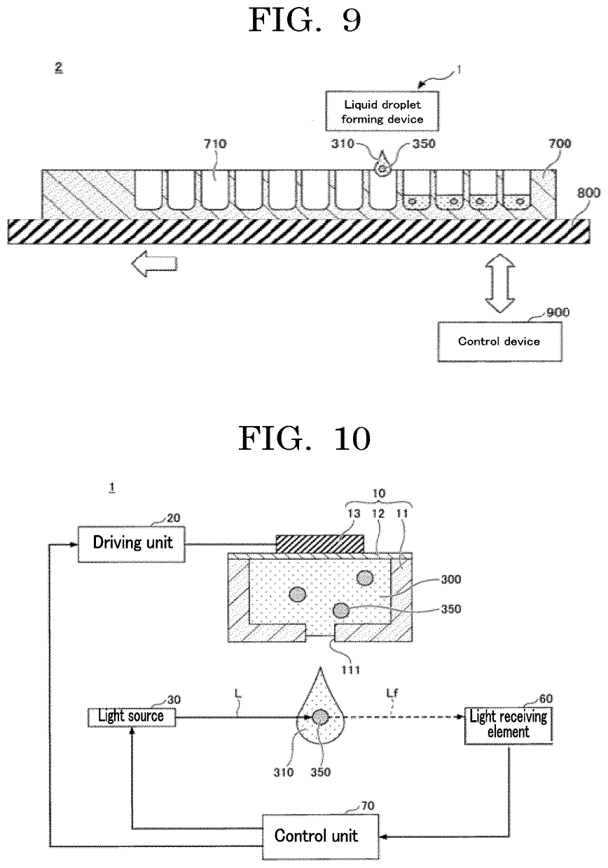

For example, in the layout of FIG. 10, when a nozzle 111 and a landing target are brought close to each other, there is a risk of occurrence of interference between the landing target (although not illustrated in FIG. 10, corresponding to, for example, the cell contained container 700 of FIG. 9) and the optical system (particularly, the light receiving element 60) of the liquid droplet forming device 1. With the layout of FIG. 14, occurrence of interference can be avoided.

That is, by installing the light receiving element 60 in a region present in a direction opposite to a direction in which a liquid droplet is discharged from a discharging surface of the liquid droplet discharging unit as illustrated in FIG. 14, it is possible to reduce the distance (gap) between the landing target on which a liquid droplet 310 is landed and the nozzle 111 and suppress landing on a wrong position. As a result, the dispensing accuracy can be improved.

FIG. 15 is an exemplary diagram illustrating another modified example of the liquid droplet forming device of FIG. 10. As illustrated in FIG. 15, a liquid droplet forming device 1B is different from the liquid droplet forming device 1 (see FIG. 10) in that a light receiving element 61 configured to receive fluorescence Lf₂ emitted by the fluorescent-stained cell 350 is provided in addition to the light receiving element 60 configured to receive fluorescence Lf₁ emitted by the fluorescent-stained cell 350. Description about components that are the same as in the embodiment already described may be skipped.

The fluorescences Lf₁ and Lf₂ represent parts of fluorescence emitted to all directions from the fluorescent-stained cell 350. The light receiving elements 60 and 61 can be disposed at arbitrary positions at which the fluorescence emitted to different directions by the fluorescent-stained cell 350 is receivable. Three or more light receiving elements may be disposed at positions at which the fluorescence emitted to different directions by the fluorescent-stained cell 350 is receivable. The light receiving elements may have the same specifications or different specifications.

With one light receiving element, when a plurality of fluorescent-stained cells 350 are contained in a flying liquid droplet 310, there is a risk that the cell number counting unit 703 may erroneously count the number of fluorescent-stained cells 350 contained in the liquid droplet 310 (a risk that a counting error may occur) because the fluorescent-stained cells 350 may overlap each other.

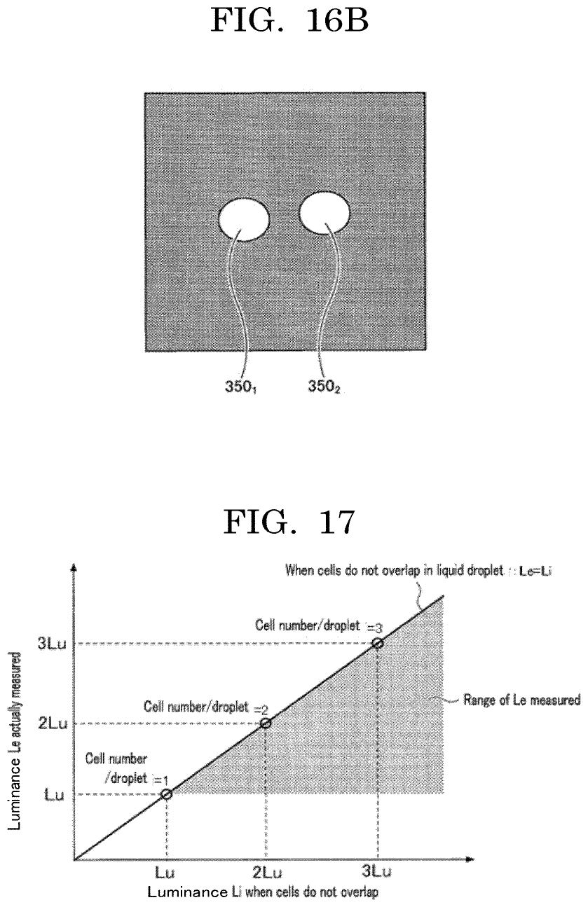

FIG. 16A and FIG. 16B are diagrams illustrating a case where two fluorescent-stained cells are contained in a flying liquid droplet. For example, as illustrated in FIG. 16A, there may be a case where fluorescent-stained cells 3501 and 3502 overlap each other, or as illustrated in FIG. 16B, there may be a case where the fluorescent-stained cells 3501 and 3502 do not overlap each other. By providing two or more light receiving elements, it is possible to reduce the influence of overlap of the fluorescent-stained cells.

As described above, the cell number counting unit 703 can count the number of fluorescent particles, by calculating the luminance or the area value of fluorescent particles by image processing and comparing the calculated luminance or area value with a predetermined threshold.

When two or more light receiving elements are installed, it is possible to suppress occurrence of a counting error, by adopting the data indicating the maximum value among the luminance values or area values obtained from these light receiving elements. This will be described in more detail with reference to FIG. 17.

FIG. 17 is a graph plotting an example of a relationship between a luminance Li when particles do not overlap each other and a luminance Le actually measured. As plotted in FIG. 17, when particles in the liquid droplet do not overlap each other, Le is equal to Li. For example, in the case where the luminance of one cell is assumed to be Lu, Le is equal to Lu when the number of cells per droplet is one, and Le is equal to nLu when the number of particles per droplet is n (n: natural number).

However, actually, when n is 2 or greater, because particles may overlap each other, the luminance to be actually measured is Lu≤Le≤nLu (the half-tone dot meshed portion in FIG. 17). Hence, when the number of cells per droplet is n, the threshold may be set to, for example, (nLu−Lu/2)≤threshold<(nLu+Lu/2). When a plurality of light receiving elements are installed, it is possible to suppress occurrence of a counting error, by adopting the maximum value among the data obtained from these light receiving elements. An area value may be used instead of luminance.

When a plurality of light receiving elements are installed, the number of particles may be determined according to an algorithm for estimating the number of cells based on a plurality of shape data to be obtained.

As can be understood, with the plurality of light receiving elements configured to receive fluorescence emitted to different directions by the fluorescent-stained cell 350, the liquid droplet forming device 1B can further reduce the frequency of occurrence of erroneous counting of the number of fluorescent-stained cells 350.

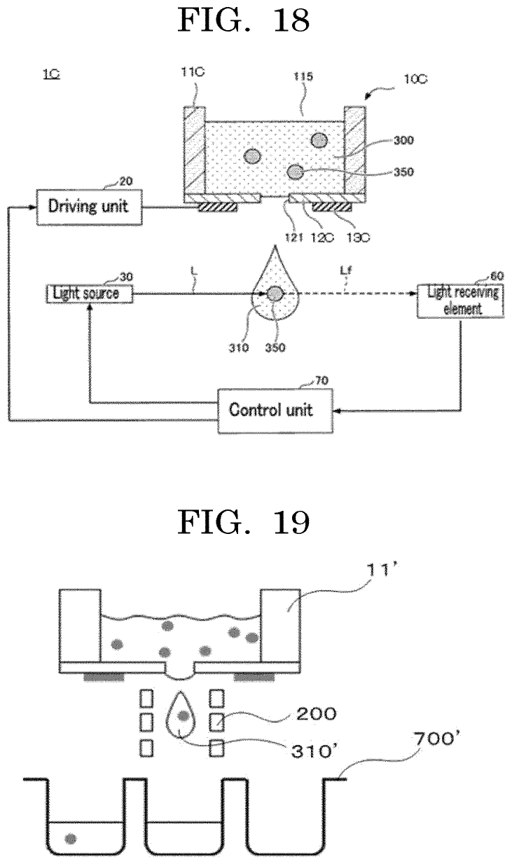

FIG. 18 is an exemplary diagram illustrating another modified example of the liquid droplet forming device of FIG. 10. As illustrated in FIG. 18, a liquid droplet forming device 1C is different from the liquid droplet forming device 1 (see FIG. 10) in that a liquid droplet discharging unit 10C is provided instead of the liquid droplet discharging unit 10. Description about components that are the same as in the embodiment already described may be skipped.

The liquid droplet discharging unit 10C includes a liquid retaining unit 11C, a membrane 12C, and a driving element 13C. At the top, the liquid retaining unit 11C has an atmospherically exposed portion 115 configured to expose the interior of the liquid retaining unit 11C to the atmosphere, and air bubbles mixed in the cell suspension 300 can be evacuated through the atmospherically exposed portion 115.

The membrane 12C is a membranous member secured at the lower end of the liquid retaining unit 11C. A nozzle 121, which is a through hole, is formed in approximately the center of the membrane 12C, and the vibration of the membrane 12C causes the cell suspension 300 retained in the liquid retaining unit 11C to be discharged through the nozzle 121 in the form of a liquid droplet 310. Because the liquid droplet 310 is formed by the inertia of the vibration of the membrane 12C, it is possible to discharge the cell suspension 300 even when the cell suspension 300 has a high surface tension (a high viscosity). The planer shape of the membrane 12C may be, for example, a circular shape, but may also be, for example, an elliptic shape or a quadrangular shape.

The material of the membrane 12C is not particularly limited. However, if the material of the membrane 12C is extremely flexible, the membrane 12C easily undergo vibration and is not easily able to stop vibration immediately when there is no need for discharging. Therefore, a material having a certain degree of hardness is preferable. As the material of the membrane 12C, for example, a metal material, a ceramic material, and a polymeric material having a certain degree of hardness can be used.

Particularly, when a cell is used as the fluorescent-stained cell 350, the material of the membrane is preferably a material having a low adhesiveness with the cell or proteins. Generally, adhesiveness of cells is said to be dependent on the contact angle of the material with respect to water. When the material has a high hydrophilicity or a high hydrophobicity, the material has a low adhesiveness with cells. As the material having a high hydrophilicity, various metal materials and ceramics (metal oxides) can be used. As the material having a high hydrophobicity, for example, fluororesins can be used.

Other examples of such materials include stainless steel, nickel, and aluminum, and silicon dioxide, alumina, and zirconia. In addition, it is conceivable to reduce cell adhesiveness by coating the surface of the material. For example, it is possible to coat the surface of the material with the metal or metal oxide materials described above, or coat the surface of the material with a synthetic phospholipid polymer mimicking a cellular membrane (e.g., LIPIDURE available from NOF Corporation).

It is preferable that the nozzle 121 be formed as a through hole having a substantially perfect circle shape in approximately the center of the membrane 12C. In this case, the diameter of the nozzle 121 is not particularly limited but is preferably two times or more greater than the size of the fluorescent-stained cell 350 in order to prevent the nozzle 121 from being clogged with the fluorescent-stained cell 350. When the fluorescent-stained cell 350 is, for example, an animal cell, particularly, a human cell, the diameter of the nozzle 121 is preferably 10 micrometers or greater and more preferably 100 micrometers or greater in conformity with the cell used, because a human cell typically has a size of about from 5 micrometers through 50 micrometers.

On the other hand, when a liquid droplet is extremely large, it is difficult to achieve an object of forming a minute liquid droplet. Therefore, the diameter of the nozzle 121 is preferably 200 micrometers or less. That is, in the liquid droplet discharging unit 10C, the diameter of the nozzle 121 is typically in the range of from 10 micrometers through 200 micrometers.

The driving element 13C is formed on the lower surface of the membrane 12C. The shape of the driving element 13C can be designed to match the shape of the membrane 12C. For example, when the planar shape of the membrane 12C is a circular shape, it is preferable to form a driving element 13C having an annular (ring-like) planar shape around the nozzle 121. The driving method for driving the driving element 13C may be the same as the driving method for driving the driving element 13. The driving unit 20 can selectively (for example, alternately) apply to the driving element 13C, a discharging waveform for vibrating the membrane 12C to form a liquid droplet 310 and a stirring waveform for vibrating the membrane 12C to an extent until which a liquid droplet 310 is not formed.

For example, the discharging waveform and the stirring waveform may both be rectangular waves, and the driving voltage for the stirring waveform may be set lower than the driving voltage for the discharging waveform. This makes it possible for a liquid droplet 310 not to be formed by application of the stirring waveform. That is, it is possible to control the vibration state (degree of vibration) of the membrane 12C depending on whether the driving voltage is high or low.

In the liquid droplet discharging unit 10C, the driving element 13C is formed on the lower surface of the membrane 12C. Therefore, when the membrane 12 is vibrated by means of the driving element 13C, a flow can be generated in a direction from the lower portion to the upper portion in the liquid retaining unit 11C.

Here, the fluorescent-stained cells 350 move upward from lower positions, to generate a convection current in the liquid retaining unit 11C to stir the cell suspension 300 containing the fluorescent-stained cells 350. The flow from the lower portion to the upper portion in the liquid retaining unit 11C disperses the settled, aggregated fluorescent-stained cells 350 uniformly in the liquid retaining unit 11C.

That is, by applying the discharging waveform to the driving element 13C and controlling the vibration state of the membrane 12C, the driving unit 20 can cause the cell suspension 300 retained in the liquid retaining unit 11C to be discharged through the nozzle 121 in the form of a liquid droplet 310. Further, by applying the stirring waveform to the driving element 13C and controlling the vibration state of the membrane 12C, the driving unit 20 can stir the cell suspension 300 retained in the liquid retaining unit 11C. During stirring, no liquid droplet 310 is discharged through the nozzle 121.

In this way, stirring the cell suspension 300 while no liquid droplet 310 is being formed can prevent settlement and aggregation of the fluorescent-stained cells 350 over the membrane 12C and can disperse the fluorescent-stained cells 350 in the cell suspension 300 without unevenness. This can suppress clogging of the nozzle 121 and variation in the number of fluorescent-stained cells 350 in the liquid droplets 310 to be discharged. This makes it possible to stably discharge the cell suspension 300 containing the fluorescent-stained cells 350 in the form of liquid droplets 310 continuously for a long time.

In the liquid droplet forming device 1C, air bubbles may mix in the cell suspension 300 in the liquid retaining unit 11C. Also in this case, the liquid droplet forming device 1C can emit the air bubbles mixed in the cell suspension 300 to the outside air through the atmospherically exposed portion 115 provided at the top of the liquid retaining unit 11C. This enables continuous, stable formation of liquid droplets 310 without a need for disposing of a large amount of the liquid for air bubble elimination.

That is, the discharging state is affected when mixed air bubbles are present at a position near the nozzle 121 or when many mixed air bubbles are present over the membrane 12C. Therefore, in order to perform stable formation of liquid droplets for a long time, there is a need for eliminating the mixed air bubbles. Typically, mixed air bubbles present over the membrane 12C move upward autonomously or by vibration of the membrane 12C. Because the liquid retaining unit 11C is provided with the atmospherically exposed portion 115, the mixed air bubbles can be evacuated through the atmospherically exposed portion 115. This makes it possible to prevent occurrence of empty discharging even when air bubbles mix in the liquid retaining unit 11, enabling continuous, stable formation of liquid droplets 310.

At a timing at which a liquid droplet is not being formed, the membrane 12C may be vibrated to an extent until which a liquid droplet is not formed, in order to positively move the air bubbles upward in the liquid retaining unit 11C.

### —Electric or Magnetic Detection Method—

In the case of the electric or magnetic detection method, as illustrated in FIG. 19, a coil 200 configured to count the number of cells is installed as a sensor immediately below a discharging head configured to discharge the cell suspension onto a cell contained container 700′ from a liquid retaining unit 11′ in the form of a liquid droplet 310′. Cells are coated with magnetic beads that are modified with a specific protein and can adhere to the cells. Therefore, when the cells to which magnetic beads adhere pass through the coil, an induced current is generated to enable detection of presence or absence of the cells in the flying liquid droplet. Generally, cells have proteins specific to the cells on the surfaces of the cells. Modification of magnetic beads with antibodies that can adhere to the proteins enables adhesion of the magnetic beads to the cells. As such magnetic beads, a ready-made product can be used. For example, DYNABEADS (registered trademark) available from Veritas Corporation can be used.

The position of the sensor is not particularly limited and may be appropriately selected depending on the intended purpose. Examples of the position of the sensor include: a region between the liquid droplet discharging unit and the cell contained container; and a region other than the region between the cell contained container and the liquid droplet discharging unit, particularly a region present in a direction opposite to a direction in which a liquid droplet is discharged from a discharging surface of the liquid droplet discharging unit.

The region present in a direction opposite to a direction in which a liquid droplet is discharged from a discharging surface of the liquid droplet discharging unit means a space present at the liquid droplet discharging unit side of the surface from which a liquid droplet is discharged.

### <<Operation for Observing Cells Before Discharging>>

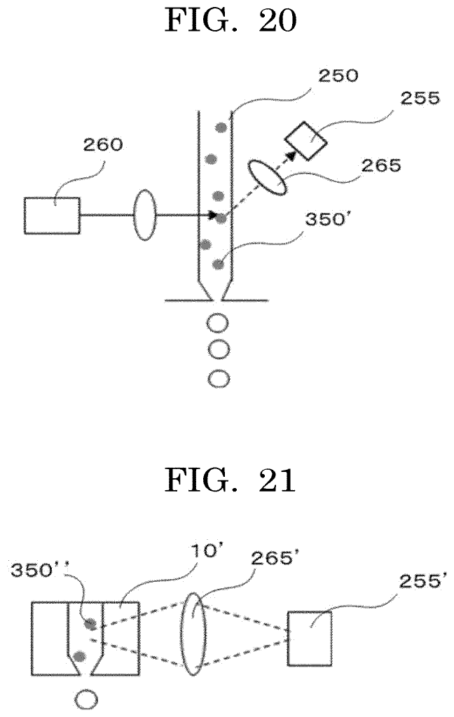

The operation for observing cells before discharging may be performed by, for example, a method for counting cells 350′ that have passed through a micro-flow path 250 illustrated in FIG. 20 or a method for capturing an image of a portion near a nozzle portion of a discharging head illustrated in FIG. 21. The method of FIG. 20 is a method used in a cell sorter device, and, for example, CELL SORTER SH800 available from Sony Corporation can be used. In FIG. 20, a light source 260 emits laser light into the micro-flow path 250, and a detector 255 detects scattered light or fluorescence through a condenser lens 265. This enables discrimination of presence or absence of cells or the kind of the cells, while a liquid droplet is being formed. Based on the number of cells that have passed through the micro-flow path 250, this method enables estimation of the number of cells that have landed in a predetermined concave. As the discharging head 10′ illustrated in FIG. 21, a single cell printer available from Cytena GmbH can be used. In FIG. 21, it is possible to estimate the number of cells that have landed in a predetermined concave, by capturing an image of the portion near the nozzle portion with an image capturing unit 255′ through a lens 265′ before discharging and estimating based on the captured image that cells 350″ present near the nozzle portion have been discharged, or by estimating the number of cells that are considered to have been discharged based on a difference between images captured before and after discharging. The method of FIG. 21 is more preferable because the method enables on-demand liquid droplet formation, whereas the method of FIG. 20 for counting cells that have passed through the micro-flow path generates liquid droplets continuously.

<<Operation for Counting Cells after Landing>>

Examples of the operation for counting cells after landing include a step of measuring the number of cells in at least one concave into which the cell suspension has been dispensed. Specifically, the operation may be performed by a method for detecting fluorescent-stained cells by observing the concaves in the cell contained container with, for example, a fluorescence microscope. This method is described in, for example, Sangjun et al., PLoS One, Volume 6(3), e17455.

Methods for observing cells before discharging a liquid droplet or after landing have the problems described below. Depending on the kind of the cell contained container to be produced, it is the most preferable to observe cells in a liquid droplet that is being discharged. In the method for observing cells before discharging, the number of cells that are considered to have landed is counted based on the number of cells that have passed through a flow path and image observation before discharging (and after discharging). Therefore, it is not confirmed whether the cells have actually been discharged, and an unexpected error may occur. For example, there may be a case where because the nozzle portion is stained, a liquid droplet is not discharged appropriately but adheres to the nozzle plate, thus failing to make the cells in the liquid droplet land. Moreover, there may occur a problem that the cells stay behind in a narrow region of the nozzle portion, or a discharging operation causes the cells to move beyond assumption and go outside the range of observation. The method for detecting cells on the cell contained container after landing also have problems. First, there is a need for preparing a container that can be observed with a microscope. As a cell contained container that can be observed, it is common to use a container having a transparent, flat bottom surface, particularly a container having a bottom surface formed of glass. However, there is a problem that such a special cell contained container is incompatible with use of ordinary concaves (for example, wells). Further, when the number of cells is large, such as some tens of cells, there is a problem that correct counting is impossible because the cells may overlap with each other. Accordingly, it is preferable to perform the operation for observing cells before discharging and the operation for counting cells after landing, in addition to counting the number of cells contained in a liquid droplet with a sensor and a particle number (cell number) counting unit after the liquid droplet is discharged and before the liquid droplet lands in a concave.

In the step of measuring the number of cells in at least one concave into which the cell suspension has been dispensed, an image of each concave is captured from the bottom side, image processing such as binarization is applied to the image to measure the number of cells, and the image is output/stored as a data file.

In addition to the step of measuring the number of cells in at least one concave into which the cell suspension has been dispensed, it is preferable to further provide a step of calculating the difference between the number of cells measured and a predetermined number of cells and a step of dispensing cells by a number amounting to the calculated difference into the one concave by an inkjet method.

In the step of calculating the difference between the number of cells measured and the predetermined number of cells, the difference from the intended number of cells is calculated based on the data measured. It is preferable to associate the calculated difference data with position information of the concave.

In the step of dispensing cells by a number amounting to the calculated difference into the one concave by an inkjet method, cells are dispensed into each concave by an inkjet method based on the difference value calculated. Hence, when there is a discrepancy between the number of cells actually dispensed into the concave and the intended (desired) number of cells, cells can be discharged into the concave precisely by an inkjet method such that the intended number of cells may be reached.

The step of calculating the difference between the number of cells measured and the predetermined number of cells and the step of dispensing cells by a number amounting to the calculated difference into the one concave by an inkjet method are performed with a view to correcting the number of cells in at least one concave.

It is also preferable to further provide a step of adjusting the cell concentration of the cell suspension retained in the liquid retaining unit based on a result of counting cells after landing. With the step of adjusting the cell concentration of the cell suspension, it is possible to suppress operations in which liquid droplets containing no cells are discharged. Hence, it is possible to suppress wasting of the solvent constituting the cell suspension and shorten the operation time.

As the light receiving element, a light receiving element including one or a small number of light receiving portion(s), such as a photodiode, an Avalanche photodiode, and a photomultiplier tube may be used. In addition, a two-dimensional sensor including light receiving elements in a two-dimensional array formation, such as a CCD (Charge Coupled Device), a CMOS (Complementary Metal Oxide Semiconductor), and a gate CCD may be used.

When using a light receiving element including one or a small number of light receiving portion(s), it is conceivable to determine the number of cells contained, based on the fluorescence intensity, using a calibration curve prepared beforehand. Here, binary detection of whether cells are present or absent in a flying liquid droplet is common.

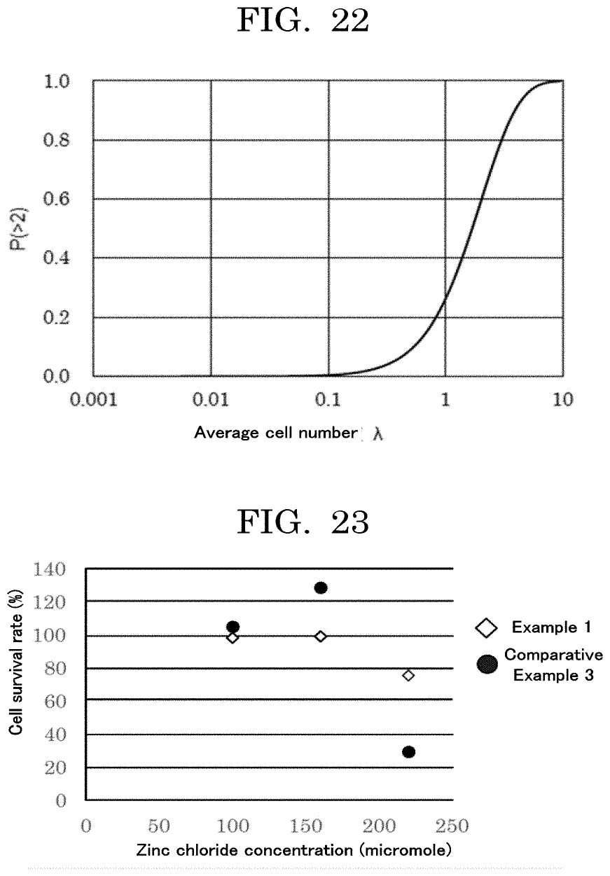

When the cell suspension is discharged in a state that the cell concentration is so sufficiently low that almost only 1 or 0 cell(s) will be contained in a liquid droplet, sufficiently accurate counting is available by the binary detection. On the premise that cells are randomly distributed in the cell suspension, the cell number in a flying liquid droplet is considered to conform to a Poisson distribution, and the probability P (>2) at which two or more cells are contained in a liquid droplet is represented by a formula (1) below. FIG. 22 is a graph plotting a relationship between the probability P (>2) and an average cell number. Here, A is a value representing an average cell number in a liquid droplet and obtained by multiplying the cell concentration in the cell suspension by the volume of a liquid droplet discharged.

P(>2)=1−(1+λ)×e^{-λ} formula (1)

When performing cell number counting by binary detection, in order to ensure accuracy, it is preferable that the probability P (>2) be a sufficiently low value, and that A satisfy: λ<0.15, at which the probability P (>2) is 1% or lower. The light source is not particularly limited and may be appropriately selected depending on the intended purpose, so long as the light source can excite fluorescence from cells. It is possible to use, for example, an ordinary lamp such as a mercury lamp and a halogen lamp to which a filter is applied for emission of a specific wavelength, a LED (Light Emitting Diode), and a laser. However, particularly when forming a minute liquid droplet of 1 nL or less, there is a need for irradiating a small region with a high light intensity. Therefore, use of a laser is preferable. As a laser light source, various commonly known lasers such as a solid-state laser, a gas laser, and a semiconductor laser can be used. The excitation light source may be a light source that is configured to continuously irradiate a region through which a liquid droplet passes or may be a light source that is configured for pulsed irradiation in synchronization with discharging of a liquid droplet at a timing delayed by a predetermined period of time from the operation for discharging the liquid droplet.

### <Liquid Droplet Landing Step>

The liquid droplet landing step is a step of landing the liquid droplet in at least one concave in a manner that a predetermined number of cells are located in the at least concave.

A predetermined number means an arbitrarily set number. Here, what is meant is that the number of cells to be located in each concave is arbitrarily set.

As the predetermined number, the same number of cells may be located in all concaves of the cell contained container, or a plurality of groups (each group may also be referred to as “level”) of cells containing the same number of cells may be provided in each concave.

Locating means providing a predetermined article at a predetermined position.

Landing means making liquid droplets reach the concaves.

The method for landing a liquid droplet is not particularly limited and may be appropriately selected depending on the intended purpose. Examples of the method include a method of repeating locating liquid droplets in one concave until the predetermined number set for the concave is reached, and then landing liquid droplets into another concave until the predetermined number set for that concave is reached, and a method of sequentially locating liquid droplets in the concaves until the predetermined numbers set for the respective concaves are reached.

“Sequentially” means “in order”.

In FIG. 9, in the cell contained container producing method of the present disclosure, a cell contained container in which concaves (concaves) are formed is secured on a movable stage, and by combination of driving of the stage with formation of liquid droplets from the discharging head, liquid droplets are sequentially landed in the concaves (concaves). A method of moving the cell contained container along with moving the stage is described here. However, naturally, it is also possible to move the discharging head.

FIG. 9 is a schematic diagram illustrating an example of a device configured to land liquid droplets sequentially into concaves of a cell contained container.

As illustrated in FIG. 9, a device (dispensing device) 2 configured to land liquid droplets includes a liquid droplet forming unit 1, a stage 800, and a control device 900.

A cell contained container 700 is disposed over a movable stage 800. The cell contained container 700 has a plurality of concaves 710 (concaves) in which liquid droplets 310 discharged from a discharging head of the liquid droplet forming unit 1 land. The control device 900 is configured to move the stage 800 and control the relative positional relationship between the discharging head of the liquid droplet forming unit 1 and each concave 710. This enables liquid droplets 310 containing fluorescent-stained cells 350 to be discharged sequentially into the concaves 710 from the discharging head of the liquid droplet forming unit 1.

The control device 900 may be configured to include, for example, a CPU, a ROM, a RAM, and a main memory. In this case, various functions of the control device 900 can be realized by a program recorded in, for example, the ROM being read out into the main memory and executed by the CPU. However, a part or the whole of the control device 900 may be realized only by hardware. Alternatively, the control device 900 may be configured with, for example, physically a plurality of devices.

When landing the cell suspension into the concaves, it is preferable to land the liquid droplets to be discharged into the concaves, in a manner that a plurality of levels are obtained.

A plurality of levels mean a plurality of references serving as standards.

The plurality of levels mean a predetermined concentration gradient of the cell contained container, obtained by, for example, locating different plural numbers of cells including a nucleic acid having a specific base sequence in different concaves. With a concentration gradient, the cells can be favorably used as a reagent for calibration curve. The plurality of levels can be controlled using values counted by the sensor.

### <Step of Calculating Degrees of Certainty of Estimated Numbers of Cells in Cell Suspension Producing Step and Liquid Droplet Landing Step>

The step of calculating degrees of certainty of estimated numbers of cells in the cell suspension producing step and the liquid droplet landing step is a step of calculating the degree of certainty in each of the cell suspension producing step and the liquid droplet landing step.

The degree of certainty of an estimated number of cells can be calculated in the same manner as calculating the degree of certainty in the cell suspension producing step.

The timing at which the degrees of certainty are calculated may be collectively in the next step to the cell number counting step as illustrated in FIG. 4, or may be at the end of each of the cell suspension producing step and the liquid droplet landing step in order for the degrees of certainty to be summed in the next step to the cell number counting step. In other words, the degrees of certainty in these steps need only to be calculated at arbitrary timings by the time when summing is performed.

### <Outputting Step>

The outputting step is a step of outputting a counted value of the number of cells contained in the cell suspension that has landed in a concave, counted by a particle number counting unit based on a detection result measured by a sensor.

The counted value means a total number of cells contained in the concave, calculated by the particle number counting unit based on the detection result measured by the sensor.

The particle number counting unit is a unit configured to count up the number of cells measured by a sensor to calculate a total value.

Outputting means sending a value counted by a device such as a motor, communication equipment, and a calculator upon reception of an input to an external server serving as a count result memory unit in the form of electronic information, or printing the counted value as a printed matter.

In the outputting step, an observed value or an estimated value obtained by observing or estimating the number of cells in each concave of a cell contained container during production of the cell contained container is output to an external memory unit.

Outputting may be performed at the same time as the cell number counting step, or may be performed after the cell number counting step.

### <Recording Step>

The recording step is a step of recording the observed value or the estimated value output in the outputting step.

The recording step can be suitably performed by a recording unit.

Recording may be performed at the same time as the outputting step, or may be performed after the outputting step.

Recording means not only supplying information to a recording medium but also storing information in a memory unit.

Next, a flowchart of an example of the cell contained container producing method of the present disclosure for a case of dispensing the cell suspension by an inkjet method after dispensing by a dispenser is performed is illustrated in FIG. 5C, and each step will be described below.

FIG. 5C is a flowchart illustrating an example of the cell contained container producing method of the present disclosure. FIG. 5C is a diagram illustrating a case of performing dispensing by an inkjet method after dispensing by a dispenser is performed. The flow of this case is the same as the flow of the case of performing dispensing only by an inkjet method, except that a step of dispensing the cell suspension by a dispenser is inserted before the step S101 illustrated in FIG. 5A.

In the step S201, the cell suspension is dispensed into at least one concave by a dispenser.

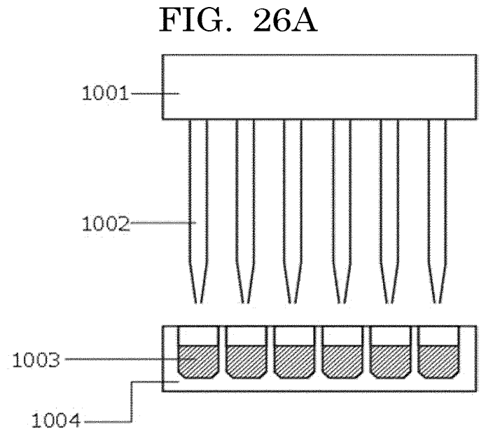

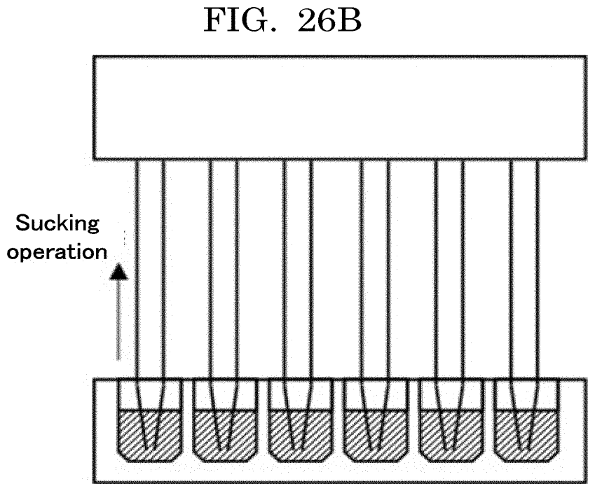

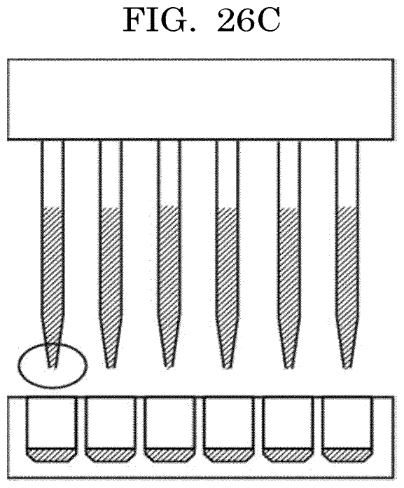

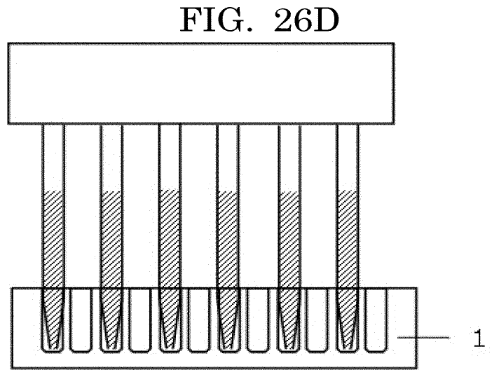

Dispensing by a dispenser in the step S201 is performed with an operation as illustrated in FIG. 26A to FIG. 26D.

As illustrated in FIG. 26A, dispensing by a dispenser uses a dispenser head 1001 mounted with pipette chips 1002 and a reservoir 1004 configured to store a cell suspension (liquid to be dispensed) 1003 previously adjusted to a predetermined concentration.

First, as illustrated in FIG. 26B, the dispenser head 1001 is moved downward to suck the cell suspension 1003 stored in the reservoir 1004 into each pipette chip 1002. Here, if the cell suspension 1003 is put in the reservoir 1004 in an excessive amount relative to the amount needed to be dispensed as illustrated in FIG. 26C, it is possible to prevent variation in the amount to be sucked into the pipette chips 1002, and mixing of bubbles due to variation in the volume of the pipettes. If bubbles are mixed, observation, image capturing, and cell number counting in the concaves after the cell suspension 1003 is dispensed into the concaves may be disturbed. In the sucking operation, it is preferable to suck the cell suspension 1003 into the pipette chips 1002 excessively relative to the amount of the cell suspension needed to be dispensed into the concaves. By sucking the cell suspension into the pipette chips 1002 in an excessive amount, it is possible to prevent bubbles from mixing into the concaves when discharging the whole cell suspension 1003 in the pipette chips 1002.

Next, as illustrated in FIG. 26D, the dispenser head 1001 after the sucking operation is moved to above the target concaves, to dispense the sucked cell suspension 1003 into the concaves in a desired amount.

In the step S202, the number of cells dispensed into at least one concave is counted. As the method for counting the number of cells in a concave, the same method as described above may be used.

In the step S203, it is determined whether the number of cells in the at least one concave has reached a predetermined value. That is, in the step S203, the flow is moved to the step S101 when it is determined that the number of cells dispensed into the at least one concave (and are actually present in the concave), counted in the step S202, has not reached the predetermined value (set number), whereas the flow is terminated when it is determined that the number of cells dispensed into the at least one concave has reached the predetermined value.

The flow from the step S101 is the same as the case of dispensing the cell suspension only by dispensing by an inkjet method. Hence, description will be skipped.

By dispensing the cell suspension by an inkjet method after dispensing by a dispenser is performed, it is possible to improve the productivity and suppress the dead volume.

The cell contained container produced by the cell contained container producing method of the present disclosure can be widely used in, for example, biotechnology-related industries, life science industries, and health care industries, and can be suitably used for purposes such as an evaluation test using cells.

### (Cell Chip)

A cell chip of the present disclosure is a cell chip including at least two concaves containing cells. The concaves include at least a first concave containing cells of a first kind and a second concave containing cells of a second kind. The minimum center-to-center distance between the concaves is 5.0 mm or less.

The cells in the cell chip of the present disclosure are not particularly limited so long as the cells include at least two kinds of cells, namely cells of a first kind and cells of a second kind. The same cells as the cells used in the cell contained container of the present disclosure can be used. Therefore, description about the cells will be skipped.

The concaves in the cell chip of the present disclosure are not particularly limited so long as the concaves include at least a first concave containing the cells of the first kind and a second concave containing the cells of the second kind. The same concaves as the concaves in the cell contained container of the present disclosure can be used. Therefore, description about the concaves will be skipped.

Further, the minimum center-to-center distance between the concaves in the cell chip of the present disclosure means the same as the shortest distance between the centers of most closely adjacent two concaves in the cell contained container of the present disclosure. Therefore, a detailed description about the minimum center-to-center distance between the concaves will be skipped.

### EXAMPLES

The present disclosure will be described below by way of Examples. The present disclosure should not be construed as being limited to these Examples.

### Production Example 1

### <Production of Cell Contained Container 1>

### —Preparation Example of Cell Dispersion Liquid A—

Human induced iPS cells A were seeded over a 10 cm dish, cultured with STEMFIT AK02N (available from Ajinomoto Co., Inc.) for 7 days at 37 degrees C., and stripped. The resultant was again seeded over a 24-well plate with a different culture medium “MEDIUM N9” included in QUICK-NEURON MIXED SEV COMPONENT KIT available from Elixirgen Scientific, LLC, and with addition of a D1 solution included in QUICK-NEURON MIXED SEV COMPONENT KIT available from Elixirgen Scientific, LLC at a final concentration of 0.1%, cultured for 2 days at 33 degrees C. at a 5% CO₂ concentration, to start nerve cell induction. On the third day of culturing, the cells were stripped from the dish and dispersed in a PBS (phosphate buffered saline) solution, to prepare a cell dispersion liquid A. Note that the iPS cells A were genetically modified to express free GFP protein during differentiation to nerve cells A.

### —Preparation Example of Cell Dispersion Liquid B—

A cell dispersion liquid B was prepared in the same manner as in Preparation example of cell dispersion liquid A, except that unlike in Preparation example of cell dispersion liquid A, different human induced iPS cells B were used. Note that the iPS cells B were genetically modified to express free GFP protein during differentiation to nerve cells B.

### —Location and Filling of Cells in Concaves—

A 384-well plate (available from Thermo Fisher Scientific Inc., with a shortest pitch of 4.5 mm) on which MEDIUM N9 included in QUICK-NEURON MIXED SEV COMPONENT KIT available from Elixirgen Scientific, LLC was dispensed in 200 microliters per concave was set over a stage of an automated dispenser (BRAVO AUTOMATED LIQUID HANDLING PLATFORM available from Agilent Technologies Japan, Ltd., a dispenser method). Before the well plate was set in the apparatus, UV lamp irradiation was performed for about 15 minutes to sterilize the interior of the apparatus.

With the automated dispenser, the cell dispersion liquid A (with a cell concentration of 5×10⁵ cells/mL) and the cell dispersion liquid B (with a cell concentration of 5×10⁵ cells/mL) were each dispensed (S201 in FIG. 5C) and filled in 16 concaves in a manner that the number of cells would be 500 cells, 1,000 cells, and 1,500 cells in the concaves corresponding to 96 wells in the center of the 384-well plate. Here, subsequently, the number of cells in the concaves filled was counted (S202 in FIG. 5C), to determine whether the number of cells had reached a predetermined number (S203 in FIG. 5C).

When the number of cells dispensed into the concaves by the automated dispenser had not reached the predetermined number, dispensing of the cell dispersion liquid A and the cell dispersion liquid B by an inkjet method was performed (S101 in FIG. 5C).

Discharging heads filled with the prepared cell dispersion liquid A and cell dispersion liquid B respectively were set in an inkjet apparatus (developed apparatus name: IJ-MINI available from Ricoh Company, Ltd.), and the inkjet apparatus was adjusted for alignment of the droplet landing position to the center of a concave and for adjustment of discharging stability.

After the adjustment of the inkjet apparatus, the cell dispersion liquid A and the cell dispersion liquid B were each discharged by an inkjet method to fill cells into the concaves corresponding to the 96 wells filled as described above by a number amounting to the difference from the predetermined value while referring to the result of counting the number of cells in each concave. During discharging of the cell dispersion liquid A and the cell dispersion liquid B, the number of cells in a flying liquid droplet after having been discharged was counted with laser light (S102 in FIG. 5C), and the number of cells in a concave after landing was counted with a microscope (S104 in FIG. 5C), to perform filling while performing the correction process as illustrated in the steps S103 and S105 in FIG. 5C when the “number of cells in a liquid droplet after having been discharged” and the “number of cells in a concave after landing” had not reached a predetermined number of cells (S106 in FIG. 5C). After filling was completed, the well plate was subjected to culturing in a 5% CO₂ incubator (available from Panasonic Corporation) for 30 minutes, to promote adhesion to the well plate. After the culturing for 30 minutes, a culture medium “MEDIUM N9” included in QUICK-NEURON MIXED SEV COMPONENT KIT available from Elixirgen Scientific, LLC was dispensed in the concaves filled with the cells and concaves surrounding the concaves filled with the cells in 200 microliters per concave of the well plate, followed by culturing for 4 days in a 5% CO₂ incubator, to produce a cell contained container 1.

### —Cell Number Counting—

The well plate after the culturing for 4 days was observed with a fluorescence microscope (available from Carl Zeiss, AXIO OBSERVER D1), with irradiation of each concave with excitation light of 488 nm. Based on an image captured by the fluorescence microscope observation, a binary image was generated using image processing software IMAGE J, to count the number of cells. Based on the obtained results, average values x, standard deviations s, and filling accuracy CV values were calculated. The results are presented in Table 2.

TABLE 2

| Number of liquid | | Average cell | Standard deviation | CV value (%) |
|---|---|---|---|---|
| droplets (droplet) | | number (x) | (s) | [(s/x) × 100] |
| 500 | Nerve | 520 | 75 | 14.4 |
| | cells A | | | |
| | Nerve | 485 | 62 | 12.7 |
| | cells B | | | |
| 1,000 | Nerve | 950 | 123 | 12.9 |
| | cells A | | | |
| | Nerve | 1,032 | 110 | 10.6 |
| | cells B | | | |
| 1,500 | Nerve | 1,560 | 162 | 10.3 |
| | cells A | | | |
| | Nerve | 1,485 | 135 | 9.1 |
| | cells B | | | |

### Production Example 2

### <Production of Cell Contained Container 2>

### —Preparation Example of Cell Dispersion Liquid C—

Human induced iPS cells C were seeded over a 10 cm dish, cultured with STEMFIT AK02N (available from Ajinomoto Co., Inc.) for 7 days at 37 degrees C., and stripped. The resultant was again seeded over a 24-well plate with a different culture medium “MEDIUM N9” included in QUICK-NEURON MIXED SEV COMPONENT KIT available from Elixirgen Scientific, LLC, and with addition of a D1 solution included in QUICK-NEURON MIXED SEV COMPONENT KIT available from Elixirgen Scientific, LLC at a final concentration of 0.1%, cultured for 2 days at 33 degrees C. at a 5% CO₂ concentration, to start induction of differentiation to nerve cells C. On the third day of culturing, the cells were stripped from the dish and dispersed in a PBS (phosphate buffered saline) solution, to prepare a cell dispersion liquid C.

### —Preparation Example of Cell Dispersion Liquid D—

A cell dispersion liquid D was prepared in the same manner as in Preparation example of cell dispersion liquid C, except that unlike in Preparation example of cell dispersion liquid C, different human induced iPS cells D were used.

### —Preparation of Container—

A dimethyl polysiloxane (PDMS) sheet in which 192 holes having a diameter of 1.5 mm were formed at the shortest pitch of 2.25 mm (product name: SYLGARD (registered trademark) 184, available from Dow Corning Toray Co., Ltd., produced by molding and thermal curing at 100 degrees C. for 40 minutes to have a size of 25 mm×75 mm x h 0.75 mm) and a plastic slide formed of PERMANOX (available from Thermo Fisher Scientific Inc.) were immersed in 100% ethanol for 5 minutes to be sterilized. The sterilized PDMS sheet and plastic slide were pasted with each other in the wet state, and dried at room temperature. Hereinafter, the pasted product is referred to as container.

IMATRIX 511 (available from Nippi Inc.) was diluted with PBS to a final concentration of 1.5 microliters/100 microliters, to prepare a cell adhesive material, followed by sufficient mixing and stirring. Subsequently, the cell adhesive material was dropped in an amount of 1.0 microliter/concave, and left to stand still at 4 degrees C. for from 8 hours through 12 hours (or left to stand still in an incubator at 37 degrees C. for 2 hours).

After the container was left to stand still for the predetermined period, the liquid was removed with attention to drying in the concaves, washing with PBS was performed twice, and a N9 culture medium was dropped in an amount of 200 microliters each.

### —Filling of Cells in Concaves—

The produced container was set over a stage of an inkjet apparatus (developed apparatus name: IJ-MINI, available from Ricoh Company, Ltd.), and UV lamp irradiation was performed for about 15 minutes to sterilize the interior of the apparatus.

Discharging heads filled with the prepared cell dispersion liquid C and cell dispersion liquid D respectively were set in the inkjet apparatus, and the inkjet apparatus was adjusted for alignment of the droplet landing position to the center of a concave and for adjustment of discharging stability.

After the adjustment of the inkjet apparatus, the cell dispersion liquid C and the cell dispersion liquid D were each discharged and filled in 16 concaves by 500 droplets, 1,000 droplets, and 1,500 droplets in the concaves corresponding to 96 wells in the center of the container. After filling was completed, the container was subjected to culturing in a 5% CO₂ incubator (available from Panasonic Corporation) for 30 minutes, to promote adhesion to the container. After the culturing for 30 minutes, a N9 culture medium (available from Elixirgen Scientific, LLC) was dispensed in the concaves filled with the cells and concaves surrounding the concaves filled with the cells in an amount of 200 microliters per concave of the container, followed by culturing for 4 days in a 5% CO₂ incubator, to produce a cell contained container 2.

### —Cell Number Counting—

The culture medium was removed from each concave of the cell contained container after culturing for 4 days, washing with PBS was performed, and the PDMS sheet of the cell contained container was peeled away. A frame was produced with PAP PEN (product name: SUPER PAP PEN LIQUID BLOCKER, available from Cosmo Bio Co., Ltd.) in a manner to surround all of the 96 concaves in which the cells were cultured, and 4% paraformaldehyde was dropped in an amount of 500 microliters within the frame to fix the cells for 10 minutes at 4 degrees C. Subsequently, 4% paraformaldehyde was removed, and washing with PBS (200 microliters) was performed.

Next, a blocking solution obtained by adding NORMAL GOAT SERUM (available from Thermo Fisher Scientific Inc.) at a final concentration of 10% and TRITON X-100 (available from FUJIFILM Wako Pure Chemical Corporation) at a final concentration of 1% in PBS was dropped in an amount of 500 microliters onto the slide, and left to stand still for 1 hour with light shielding and moisturization, to perform blocking. Next, an anti-beta-III Tublin antibody (product name: PURIFIED ANTI-TUBULIN BETA 3 (TUBB3) ANTIBODY, available from BioLegend, Inc.) as a primary antibody was diluted 5,000-fold with PBS, to prepare a primary antibody diluted solution. After the slide was washed with PBS, the primary antibody diluted solution was dropped in an amount of 200 microliters and left to stand still at 4 degrees C. overnight.

Next, an Alexa 555 anti-mouse secondary-antibody (available from Abcam KK) as a secondary antibody was diluted 500-fold with a solution in which NORMAL GOAT SERUM was added at a final concentration of 3% and TRITON X-100 was added at a final concentration of 0.2%, to prepare a secondary antibody diluted solution. After the slide was washed with PBS, the secondary antibody diluted solution was dropped in an amount of 200 microliters and left to stand still at 4 degrees C. for 1 hour with light shielding.

Next, a DAPI sealing liquid (available from Thermo Fisher Scientific Inc.) was coated over a cover slip that was washed with PBS and then sterilized with 100% ethanol, and the cover slip was placed over the slide. Then, the slide was left to stand still at 4 degrees C. for 1 hour. Using a fluorescence microscope, the produced slide was irradiated with excitation light of 364 nm and 555 nm to confirm that nucleus and tubulin were stained and capture a fluorescence microscope image of the slide.

Based on the obtained image, the number of cells in each concave was counted using image processing software IMAGE J. Based on the obtained results, average values x, standard deviations s, and filling accuracy CV values were calculated. The results are presented in Table 3.

TABLE 3

| Number of liquid | | Average cell | Standard deviation | CV value (%) |
|---|---|---|---|---|
| droplets (droplet) | | number (x) | (s) | [(s/x) × 100] |
| 500 | Nerve | 420 | 60.2 | 14.3 |
| | cells C | | | |
| | Nerve | | | |
| | cells D | | | |
| 1,000 | Nerve | 810 | 90.5 | 11.2 |
| | cells C | | | |
| | Nerve | | | |
| | cells D | | | |
| 1,500 | Nerve | 1,180 | 124.8 | 10.0 |
| | cells C | | | |
| | Nerve | | | |
| | cells D | | | |

### Production Example 3

A cell contained container 3 was produced in the same manner as in Production example 2, except that unlike in Production example 2, cells were filled in a predetermined number in each concave by a manual operation (with a multi-channel pipette, product name: P8X10L, available from Gilson, Inc.). The results are presented in Table 4.

TABLE 4

| Number of liquid | | Average cell | Standard deviation | CV value (%) |
|---|---|---|---|---|
| droplets (droplet) | | number (x) | (s) | [(s/x) × 100] |
| 500 | Nerve | 450 | 85 | 18.8 |
| | cells C | | | |
| | Nerve | | | |
| | cells D | | | |
| 1,000 | Nerve | 812 | 121 | 14.9 |
| | cells C | | | |
| | Nerve | | | |
| | cells D | | | |
| 1,500 | Nerve | 1,152 | 143 | 12.3 |
| | cells C | | | |
| | Nerve | | | |
| | cells D | | | |

### Example 1

### <Drug Efficacy Screening>

On the third day of culturing after cells were filled in the concaves in Production example 2, STAUROSPORINE (available from FUJIFILM Wako Pure Chemical Corporation) was dissolved in DMSO to prepare a drug solution at 2,000 micromoles, and the drug solution was added in the concaves at a final concentration of 0.1 micromoles, 0.3 micromoles, 1.0 micromole, 3 micromoles, or 10 micromoles, with a pipette using a 10 microliter chip (product name: PIPETEMAN, available from Eppendorf AG). The amount of the drug solution used was from 50 μL through 5,000 μL.

On the next day after the drug solution was added, the culture medium in each concave of the cell contained container was removed, and the concaves were washed with Hank's balanced salt solution (HBSS, available from Thermo Fisher Scientific Inc.) (200 microliters) at room temperature. After washing, HOECHST 33342 (available from Thermo Fisher Scientific Inc.), PI (Propidium Iodide, available from Cosmo Bio Co., Ltd.), and CALSEIN AM (available from Takara Bio Inc.) were each diluted 1,000-fold with HBSS, to prepare a stain mixture liquid, and the prepared stain mixture liquid was added in an amount of 200 microliters each. The cell contained container was then left to stand still in a 5% CO₂ incubator for 20 minutes.

A fluorescence microscope image of the cell stained container after staining was completed was captured with a fluorescence microscope. The obtained fluorescence microscope image was processed with image processing software IMAGE J, to calculate the number of cells and the number of dead cells. The results are presented in Table 5 below.

TABLE 5

| | Drug concentration | | | | | |
|---|---|---|---|---|---|---|
| | 0 | | | | | |
| | micro- | 0.1 | 0.3 | 1.0 | 3.0 | 10 |
| | moles | micro- | micro- | micro- | micro- | micro- |
| | (control) | moles | moles | moles | moles | moles |
| Living cells | 462 | 271 | 270 | 268 | 197 | 11 |
| (cell) | | | | | | |
| Dead cells | 138 | 116 | 202 | 223 | 270 | 474 |
| (cell) | | | | | | |
| Drug | 77% | 70% | 57% | 54% | 42% | 2% |
| efficacy | | | | | | |
| rate (living | | | | | | |
| cells/dead | | | | | | |
| cells) | | | | | | |

In the case of performing drug efficacy screening using the cell contained container of the present disclosure, the drug efficacy rate can be quantified as a ratio between cells and dead cells. Therefore, even if there is variation from concave to concave in the number of cells (the cell contained container of Example 1 had a CV value of about 20%), it is possible to perform quantitative evaluation. Further, the cell contained container of the present disclosure has a small volume per concave. Therefore, the amount of the reagents (e.g., cells and drugs) used for one test can be saved. That is, it is possible to efficiently obtain experimental data needed for quantitative analyses with only one container, without using samples in a large amount.

### Example 2

### <Cytotoxicity Evaluation>

### —Cell Survival Rate—

N9 culture media (available from Elixirgen Scientific, LLC) to which zinc chloride as a test substance at four concentration conditions of 0 micromoles, 100 micromoles, 160 micromoles, and 220 micromoles was added respectively were added in the evaluation container of Production example 2 in an amount of 100 microliters with a micropipette, and the container was left to stand still overnight (for 20 hours) in a CO₂ incubator at 37 degrees C.

Next, in order to evaluate the influence of zinc chloride on the cell survival rate, a WST-1 reagent (product name: PREMIX WST-1 CELL PROLIFERATION ASSAY SYSTEM, available from Takara Bio Inc.) was added in an amount of 10 microliters per well (concave), and left to stand still for 1 hour in an CO₂ incubator at 37 degrees C. to be allowed to undergo reaction. Subsequently, absorbances at 450 nm, and as a reference value, at 570 nm were measured with a plate reader (instrument name: CYTATION 5, available from Bio Tek Instruments Inc.), to evaluate “cell survival rate”. The results are plotted in FIG. 23.

### (Cell Membrane Damage Rate)

In the same manner as in the evaluation of the cell survival rate, the N9 culture medium to which zinc chloride was added as described above was added, and the container was left to stand still overnight (for 20 hours) in a CO₂ incubator at 37 degrees C.

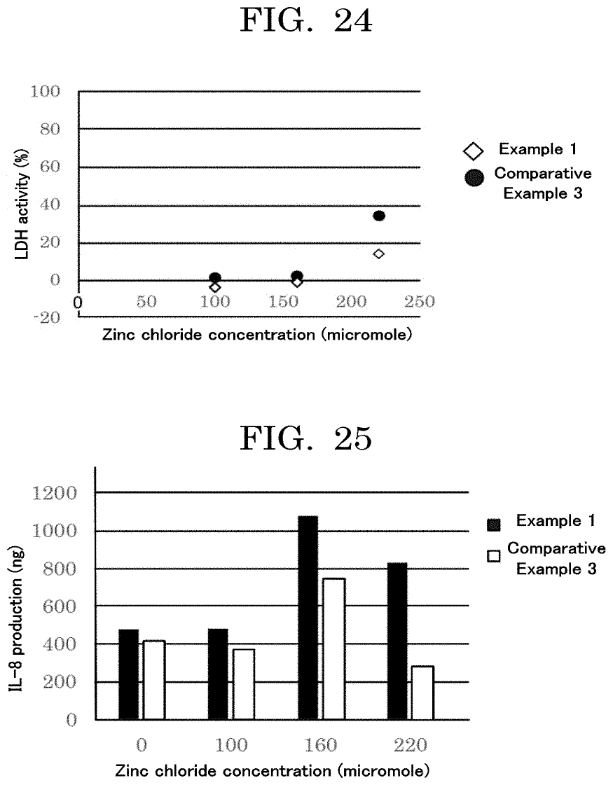

In order to evaluate the influence of zinc chloride on cell membrane damage, only the culture medium was recovered with a micropipette and put in a 96-well cell contained container, a LDH assay reagent (product name: CYTOTOXICITY DETECTION KIT, available from Roche) was further added to each, and the resultant was allowed to undergo reaction at room temperature (23 degrees C.) for 5 minutes. Subsequently, absorbances at 492 nm, and as a reference value, at 620 nm were measured with a plate reader, to evaluate “cell membrane damage rate”. The results are plotted in FIG. 24.

### (Inflammatory Substance Production)

In the same manner as in the evaluation of the cell survival rate, a N9 culture medium (available from Elixirgen Scientific, LLC) to which zinc chloride was added was added, and the container was left to stand still overnight (for 20 hours) in a CO₂ incubator at 37 degrees C.

In order to evaluate the influence of zinc chloride on inflammatory substance production, only the culture medium was recovered with a micropipette. IL-8 production was measured by ELISA method using a protein measurement kit (product name: HUMAN IL-8 ELISA READY-SET-GO! (registered trademark), available from Affymetrix), and absorbances at 450 nm, and as a reference value, at 570 nm were measured with a plate reader. The results are plotted in FIG. 25.

As can be understood from the results in FIG. 23 to FIG. 25, the nerve cells C and the nerve cells D in the cell contained container 2 of Production example 2 exhibited almost the same toxic response tendency in terms of the cell survival rate, the cell membrane damage rate, and the inflammatory substance production to zinc chloride. From these results, it can be known that the cell contained container of the present disclosure is effective for efficient evaluation of toxic response.

Aspects of the present disclosure are, for example, as follows.

<1> A cell contained container including
at least two concaves,
wherein the concaves contain cells,
wherein a number of kinds of the cells is at least two with respect to the cell contained container, and
wherein a shortest distance between centers of most closely adjacent two concaves of the concaves is 9.0 mm or less.
<2> The cell contained container according to <1>,
wherein the concaves contain a liquid, and
wherein a total liquid amount of the liquid with respect to the cell contained container is 10.0 microliters or less.
<3> The cell contained container according to <1> or <2>,
wherein a filling accuracy in terms of a number in which the cells are contained in the concaves is 30% or lower.
<4> The cell contained container according to <1> or <2>,
wherein a filling accuracy in terms of a number in which the cells are contained in the concaves is 15% or lower.
<5> The cell contained container according to any one of <1> to <4>,
wherein the cells are cells of at least any one kind selected from the group consisting of induced Pluripotent Stem (iPS) cells, differentiated cells derived from iPS cells, Embryonic Stem (ES) cells, differentiated cells derived from ES cells, and stems cells obtained from a human body.
<6> The cell contained container according to any one of <1> to <5>,
wherein the shortest distance between the centers of the at least two concaves is 4.5 mm or less.
<7> The cell contained container according to any one of <1> to <6>,
wherein the shortest distance between the centers of the at least two concaves is 2.25 mm or less.
<8> The cell contained container according to any one of <1> to <7>,
wherein the concaves further contain a cell culture liquid.
<9> The cell contained container according to any one of <1> to <8>, further including:
an identifier unit configured to enable identifying the cell contained container; and
a memory unit configured to store at least any one selected from the group consisting of information on the cell contained container and information on the cells contained in the concaves.
<10> The cell contained container according to <9>,
wherein the information on the cells is at least any one selected from the group consisting of the kinds of the cells, differentiation history of the cells, number of the cells in the concaves, and survival rate of the cells in the concaves.
<11> The cell contained container according to <9> or <10>,
wherein the memory unit is separate from the cell contained container.
<12> The cell contained container according to any one of <9> to <11>,
wherein the identifier unit is provided over the cell contained container.
<13> The cell contained container according to any one of <9> to <12>,
wherein the identifier unit is at least any one selected from the group consisting of barcode, QR code (registered trademark), Radio Frequency Identifier (RFID), letter, symbol, graphic, and color.
<14> The cell contained container according to any one of <1> to <13>,
wherein each of the concaves contains the cells of one kind.
<15> A cell contained container producing method for producing the cell contained container according to any one of <1> to <14>, the cell contained container producing method including
dispensing a cell suspension containing the cells into the at least two concaves,
wherein the dispensing is performed by an inkjet method.
<16> The cell contained container producing method according to <15>,
wherein an inkjet head for the inkjet method includes at least: a liquid retaining unit configured to retain the cell suspension;
a membranous member configured to apply vibration to the cell suspension to discharge a liquid droplet; and
an atmospherically exposing unit configured to expose the liquid retaining unit to the atmosphere.
<17> The cell contained container producing method according to <16>, including
using at least two of the inkjet head simultaneously or alternately.
<18> The cell contained container producing method according to any one of <15> to <17>, further including
measuring number of the cells in at least one concave into which the cell suspension is dispensed.
<19> The cell contained container producing method according to any one of <15> to <18>, further including:
calculating a difference between the number of the cells measured and a predetermined number of cells; and
dispensing the cells by a number amounting to the calculated difference into the one concave by the inkjet method.
<20> The cell contained container producing method according to any one of <15> to <19>, further including
adjusting a cell concentration of the cell suspension.
<21> The cell contained container producing method according to any one of <15> to <20>,
in the dispensing the cell suspension containing the cells into the at least two concaves, dispensing by the inkjet method is performed after
dispensing by a dispenser is performed.
<22> A cell chip including
at least two concaves containing cells,
wherein the concaves include at least a first concave containing cells of a first kind and a second concave containing cells of a second kind, and
wherein a minimum center-to-center distance between the concaves is 5.0 mm or less.

The cell contained container according to any one of <1> to <14>, the cell contained container producing method according to an one of <15> to <21>, and the cell chip according to <22> can solve the various problems in the related art and can achieve the object of the present disclosure.

What is claimed is:

1. A cell contained container comprising
at least two concaves,
wherein the concaves comprise cells,
wherein a number of kinds of the cells is at least two with respect to the cell contained container, and
wherein a shortest distance between centers of most closely adjacent two concaves of the concaves is 9.0 mm or less.

2. The cell contained container according to claim 1,
wherein the concaves comprise a liquid, and
wherein a total liquid amount of the liquid with respect to the concaves is 10.0 microliters or less.

3. The cell contained container according to claim 1,
wherein a filling accuracy in terms of a number in which the cells are contained in the concaves is 30% or lower.

4. The cell contained container according to claim 1,
wherein a filling accuracy in terms of a number in which the cells are contained in the concaves is 15% or lower.

5. The cell contained container according to claim 1,
wherein the shortest distance between the centers of the at least two concaves is 4.5 mm or less.

6. The cell contained container according to claim 1,
wherein the shortest distance between the centers of the at least two concaves is 2.25 mm or less.

7. The cell contained container according to claim 1,
wherein the concaves further comprise a cell culture liquid.

8. The cell contained container according to claim 1, further comprising:
an identifier unit configured to enable identifying the cell contained container; and
a memory unit configured to store at least any one selected from the group consisting of information on the cell contained container and information on the cells contained in the concaves.

9. The cell contained container according to claim 8,
wherein the information on the cells is at least any one selected from the group consisting of the kinds of the cells, differentiation history of the cells, number of the cells in the concaves, and survival rate of the cells in the concaves.

10. The cell contained container according to claim 8,
wherein the memory unit is separate from the cell contained container.

11. The cell contained container according to claim 8,
wherein the identifier unit is provided over the cell contained container.

12. The cell contained container according to claim 8,
wherein the identifier unit is at least any one selected from the group consisting of barcode, QR code (registered trademark), Radio Frequency Identifier (RFID), letter, symbol, graphic, and color.

13. A cell contained container producing method for producing the cell contained container according to claim 1, the cell contained container producing method comprising
dispensing a cell suspension that comprises the cells into the at least two concaves,
wherein the dispensing is performed by an inkjet method.

14. The cell contained container producing method according to claim 13,
wherein an inkjet head for the inkjet method comprises at least:
a liquid retaining unit configured to retain the cell suspension;
a membranous member configured to apply vibration to the cell suspension to discharge a liquid droplet; and
an atmospherically exposing unit configured to expose the liquid retaining unit to atmosphere.

15. The cell contained container producing method according to claim 14, comprising
using at least two of the inkjet head simultaneously or alternately.

16. The cell contained container producing method according to claim 13, further comprising
measuring number of the cells in at least one concave into which the cell suspension is dispensed.

17. The cell contained container producing method according to claim 16, further comprising:
calculating a difference between the number of the cells measured and a predetermined number of cells; and
dispensing the cells by a number amounting to the calculated difference into the one concave by the inkjet method.

18. The cell contained container producing method according to claim 13, further comprising
adjusting a cell concentration of the cell suspension.

19. The cell contained container producing method according to claim 13,
in the dispensing the cell suspension that comprises the cells into the at least two concaves, dispensing by the inkjet method is performed after dispensing by a dispenser is performed.

20. A cell chip comprising
at least two concaves that comprise cells,
wherein the concaves comprise at least a first concave that comprises cells of a first kind and a second concave that comprises cells of a second kind, and
wherein a minimum center-to-center distance between the concaves is 5.0 mm or less.
